(19) United States
(12) Patent Application Publication
(10) Pub. No.: US 2025/0143197 A1
(43) Pub. Date: May 8, 2025

(54) WORK VEHICLE, CONTROL METHOD AND COMPUTER PROGRAM

(71) Applicant: Kubota Corporation, Osaka (JP)

(72) Inventors: Tomohiro KINOSHITA, Sakai-shi (JP); Koichi KURODA, Sakai-shi (JP); Takuya TAMAI, Sakai-shi (JP)

(21) Appl. No.: 19/001,702

(22) Filed: Dec. 26, 2024

Related U.S. Application Data
(63) Continuation of application No. PCT/JP2023/021409, filed on Jun. 8, 2023.

(30) Foreign Application Priority Data
Jun. 28, 2022 (JP) 2022-103962

(51) Int. Cl. A01B 69/00; A01B 69/04

(52) U.S. Cl. CPC A01B 69/001; A01B 69/008

(57) ABSTRACT

A work vehicle includes wheels for steering, a steering device to change a steering angle of the wheels for steering, a sensor to output data indicating features around the work vehicle, and a controller to control self-traveling of the work vehicle, set a maximum steering angle for the wheels for steering based on a state of the work vehicle or its surrounding environment, detect two crop rows on opposite sides of the work vehicle based on the data, set a target path for the work vehicle in between the two crop rows, compute a target steering angle for the wheels for steering, limit the target steering angle to be equal to or smaller than a maximum steering angle when the computed target steering angle is greater than the maximum steering angle, and control the steering device so that the steering angle of the wheels for steering equals the target steering angle.

### CROSS REFERENCE TO RELATED APPLICATIONS

This application claims the benefit of priority to Japanese Patent Application No. 2022-103962 filed on Jun. 28, 2022 and is a Continuation application of PCT Application No. PCT/JP2023/021409 filed on Jun. 8, 2023. The entire contents of each application are hereby incorporated herein by reference.

### BACKGROUND OF THE INVENTION

### 1. Field of the Invention

The present disclosure relates to work vehicles, control methods, and non-transitory computer-readable media each including a computer program.

### 2. Description of the Related Art

As attempts in next-generation agriculture, research and development of smart agriculture utilizing ICT (Information and Communication Technology) and IoT (Internet of Things) are under way. Research and development are also directed to the automation and unmanned use of tractors or other work vehicles to be used in the field. For example, work vehicles which travel via automatic steering by utilizing a positioning system that is capable of precise positioning, e.g., a GNSS (Global Navigation Satellite System), are coming into practical use.

On the other hand, development of movable units which autonomously move by utilizing distance sensors, e.g., a LiDAR (Light Detection and Ranging) sensor, is also under way. For example, Japanese Laid-Open Patent Publication No. 2019-154379 discloses an example of a work vehicle which performs self-traveling in between crop rows in a field by utilizing the LiDAR sensor.

### SUMMARY OF THE INVENTION

When a work vehicle performs self-traveling among crop rows in a field, there is a desire to reduce or prevent unwanted contact of the work vehicle with the crop rows.

A work vehicle according to an example embodiment of the present disclosure is a work vehicle to perform self-traveling among a plurality of crop rows, including wheels responsible for steering, a steering device to change a steering angle of the wheels responsible for steering, an exterior sensor to output sensor data indicating a distribution of geographic features around the work vehicle, and a controller configured or programmed to control self-traveling of the work vehicle, set a maximum steering angle for the wheels responsible for steering based on a state of at least one of the work vehicle or a surrounding environment of the work vehicle, detect two crop rows existing on opposite sides of the work vehicle based on the sensor data, set a target path for the work vehicle in between the two crop rows, compute a target steering angle for the wheels responsible for steering to cause the work vehicle to follow the target path, limit a value of the target steering angle to be equal to or smaller than the maximum steering angle when the computed target steering angle is greater than the maximum steering angle, and control the steering device so that the steering angle of the wheels responsible for steering equals the target steering angle.

Example embodiments of the present disclosure may be implemented using devices, systems, methods, integrated circuits, computer programs, non-transitory computer-readable media including computer programs, or any combination thereof. The computer-readable storage media may include volatile storage media, or non-volatile storage media. Each of the devices may include a plurality of devices. In the case where one of the devices includes two or more devices, the two or more devices may include a single apparatus, or two or more separate apparatuses.

According to an example embodiment of the present disclosure, a maximum steering angle for wheels responsible for steering is set based on the state of at least one of a work vehicle and a surrounding environment of the work vehicle, and the steering angle of the wheels responsible for steering is controlled so as to be equal to or smaller than the maximum steering angle. By setting the maximum steering angle based on the state of at least one of the work vehicle and the surrounding environment, the work vehicle can be prevented from coming into contact with crop rows. By controlling the steering angle of the wheels responsible for steering so as to be equal to or smaller than the maximum steering angle, the work vehicle can be prevented from coming into contact with crop rows, and driving stability can be improved.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a side view schematically showing an example of a work vehicle and an example of an implement linked to the work vehicle.

FIG. 2 is a block diagram showing an example configuration of the work vehicle and the implement.

FIG. 3A is a schematic diagram of a LiDAR sensor as viewed in a lateral direction of the work vehicle.

FIG. 3B is a schematic diagram of a LiDAR sensor as viewed from vertically above.

FIG. 4 is a block diagram showing an example configuration of the LiDAR sensor.

FIG. 5 is a diagram schematically showing an example of an environment in which the work vehicle travels.

FIG. 6 is a perspective view schematically showing an example of a surrounding environment of the work vehicle.

FIG. 7 is a diagram showing schematically an example of a travel path of the work vehicle.

FIG. 8 is a diagram describing a method of travel control for the work vehicle in an inter-row travel mode.

FIG. 9 is a diagram describing a method of travel control for the work vehicle in an inter-row travel mode.

FIG. 10 is a diagram showing an example of an obstacle map.

FIG. 11 is a diagram showing another example of an obstacle map.

FIG. 12 is a diagram for describing a process of detecting two rows of trees based on an obstacle map.

FIG. 13 is a diagram describing a steering angle of front wheels, which are wheels responsible for steering.

FIG. 14 is a diagram showing an operation of causing the work vehicle to follow a target path.

FIG. 15 is a flowchart showing an example of a process of controlling the steering angle of the wheels responsible for steering.

FIG. 16 is a diagram showing an example of a method of setting a maximum steering angle.

FIG. 17 is a flowchart showing another example of a process of controlling the steering angle of the wheels responsible for steering.

FIG. 18 is a diagram showing work vehicles with an implement connected thereto.

FIG. 19 is a diagram showing wheelbases of work vehicles.

FIG. 20 is a diagram showing another example of a method of setting the maximum steering angle 9.

FIG. 21 is a diagram showing rows of trees.

FIG. 22 is a diagram showing rows of trees.

FIG. 23 is a diagram showing rows of trees and work vehicles.

FIG. 24 is a diagram showing a work vehicle and a ground surface on which the work vehicle travels.

### DETAILED DESCRIPTION OF THE EXAMPLE EMBODIMENTS

In the present disclosure, a “work vehicle” means a vehicle for use in performing work in a work area. A “work area” is any place where work may be performed, e.g., a field, a mountain forest, or a construction site. A “field” is any place where agricultural work may be performed, e.g., an orchard, an agricultural field, a paddy field, a cereal farm, or a pasture. A work vehicle can be an agricultural machine such as a tractor, a rice transplanter, a combine, a vehicle for crop management, or a riding mower, or a vehicle for non-agricultural purposes such as a construction vehicle or a snowplow vehicle. A work vehicle may be configured so that an implement (also referred to as a “task device” or a “task apparatus”) that is suitable for the content of work can be attached to at least one of its front and its rear. Traveling of a work vehicle that is made while it performs work by using an implement may be referred to as “tasked travel”.

“Self-driving” means controlling the travel of a vehicle based on the action of a controller, rather than through manual operation of a driver. During self-driving, not only the travel of the vehicle, but also the task operation (e.g., the operation of the implement) may also be automatically controlled. A vehicle that is traveling via self-driving is said to be “self-traveling”. The controller may be configured or programmed to control at least one of steering, adjustment of traveling speed, and starting and stopping of travel as are necessary for the travel of vehicle. In the case of controlling a work vehicle having an implement attached thereto, the controller may be configured or programmed to control operations such as raising or lowering of the implement, starting and stopping of the operation of the implement, and the like. Travel via self-driving includes not only the travel of a vehicle toward a destination along a predetermined path, but also the travel of merely following a target of tracking. A vehicle performing self-driving may travel based in part on a user's instruction. A vehicle performing self-driving may operate not only in a self-driving mode but also in a manual driving mode of traveling through manual operation of the driver. The steering of a vehicle that is based on the action of a controller, rather than manually, is referred to as “automatic steering”. A portion or an entirety of the controller may be external to the vehicle. Between the vehicle and a controller that is external to the vehicle, communication of control signals, commands, data, or the like may be performed. A vehicle performing self-driving may autonomously travel while sensing the surrounding environment, without any person being involved in the control of the travel of the vehicle. A vehicle that is capable of autonomous travel can travel in an unmanned manner. During autonomous travel, detection of obstacles and avoidance of obstacles may be performed.

An “exterior sensor” is a sensor that senses the external state of the work vehicle. Examples of exterior sensors include LiDAR sensors, cameras (or image sensors), laser range finders (also referred to as “range sensors”), ultrasonic sensors, millimeter wave radars, and magnetic sensors.

A “crop row” is a row of agricultural items, trees, or other plants that may grow in rows on a field, e.g., an orchard or an agricultural field, or in a forest or the like. In the present disclosure, a “crop row” is a notion that encompasses a “row of trees”.

An “obstacle map” is local map data in which the position or a region of an object around the work vehicle is expressed in a predetermined coordinate system. A coordinate system defining an obstacle map may be a vehicle coordinate system that is fixed to the work vehicle, or a world coordinate system that is fixed to the globe (e.g. a geographic coordinate system), for example. An obstacle map may include information other than position (e.g., attribute information) of an object around the work vehicle. The obstacle map may be expressed in various formats, e.g., a grid map or a point cloud map.

Hereinafter, example embodiments of the present disclosure will be described more specifically. Note however that unnecessarily detailed descriptions may be omitted. For example, detailed descriptions on what is well known in the art or redundant descriptions on what is substantially the same configuration may be omitted. This is to avoid lengthy description, and facilitate the understanding of those skilled in the art. The accompanying drawings and the following description are not intended to limit the scope of claims. In the following description, component elements having identical or similar functions are denoted by identical reference numerals.

The following example embodiments are only exemplary, and the techniques according to the present disclosure are not limited to the following example embodiments. For example, numerical values, shapes, materials, steps, orders of steps, etc., that are indicated in the following example embodiments are only exemplary, and allow for various modifications so long as it makes technological sense. Any one implementation may be combined with another.

Hereinafter, as one example, an example embodiment where the work vehicle is a tractor for use in agricultural work in a field such as an orchard will be described. Without being limited to tractors, the techniques according to the present disclosure are also applicable to other type of agricultural machines such as rice transplanters, combines, vehicles for crop management, or riding lawn mowers, for example. The example embodiments and techniques according to the present disclosure are also applicable to vehicles for non-agricultural purposes such as construction vehicles or snowplow vehicles.

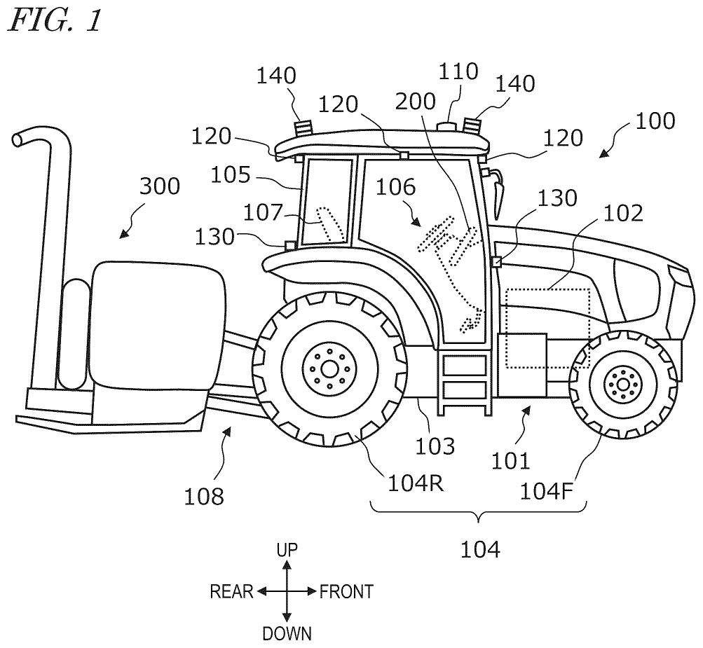

FIG. 1 is a side view schematically showing an example of the work vehicle 100 and an example of an implement 300 linked to the work vehicle 100. The work vehicle 100 according to the present example embodiment can operate both in a manual driving mode and a self-driving mode. In the self-driving mode, the work vehicle 100 is able to perform unmanned travel. The work vehicle 100 performs self-driving in an environment where a plurality of crop rows (e.g., rows of trees) are planted, e.g., an orchard such as a vineyard or an agricultural field.

As shown in FIG. 1, the work vehicle 100 includes a vehicle body 101, a prime mover (engine) 102, and a transmission 103. On the vehicle body 101, running gear, which includes wheels 104 with tires, and a cabin 105 are provided. The running gear includes four wheels 104, and wheel axes to cause the four wheels to rotate, and brakes to brake on each wheel axis. The wheels 104 include a pair of front wheels 104F and a pair of rear wheels 104R. Inside the cabin 105, a driver's seat 107, a steering device 106, an operational terminal 200, and switches for manipulation are provided. The front wheels 104F and/or the rear wheels 104R may be replaced by a plurality of wheels with a track (crawlers), rather than wheels with tires, attached thereto.

The work vehicle 100 includes a plurality of exterior sensors to sense the surroundings of the work vehicle 100. In the example of FIG. 1, the exterior sensors include a plurality of LiDAR sensors 140, a plurality of cameras 120, and a plurality of obstacle sensors 130.

The cameras 120 may be provided at the front/rear/right/left of the work vehicle 100, for example. The cameras 120 image the surrounding environment of the work vehicle 100 and generate image data. The images acquired with the cameras 120 may be transmitted to the terminal device, which is responsible for remote monitoring, for example. The images may be used to monitor the work vehicle 100 during unmanned driving. The cameras 120 may be provided according to the needs, and any number of them may be provided.

The LiDAR sensors 140 are one example of exterior sensors that output sensor data indicating a distribution of geographic features around the work vehicle 100. In the example of FIG. 1, two LiDAR sensors 140 are disposed on the cabin 105, at the front and the rear. The LiDAR sensors 140 may be provided at other positions (e.g., on a lower portion of a front face of the vehicle body 101). While the work vehicle 100 is traveling, each LiDAR sensor 140 repeatedly outputs sensor data representing the distances and directions of measurement points on objects existing in the surrounding environment, or two-dimensional or three-dimensional coordinate values of such measurement points. The number of LiDAR sensors 140 is not limited to two, but may be one, or three or more.

The LiDAR sensor(s) 140 may be configured or programmed to output two-dimensional or three-dimensional point cloud data as sensor data. In the present specification, “point cloud data” broadly means data indicating a distribution of multiple reflection points that are observed with a LiDAR sensor(s) 140. The point cloud data may include coordinate values of each reflection point in a two-dimensional space or a three-dimensional space or information indicating the distance and direction of each reflection point, for example. The point cloud data may include information of luminance of each reflection point. The LiDAR sensor(s) 140 may be configured or programmed to repeatedly output point cloud data with a pre-designated cycle, for example. Thus, the exterior sensors may include one or more LiDAR sensors 140 that output point cloud data as sensor data.

The sensor data that is output from the LiDAR sensor(s) 140 is processed by a controller configured or programmed to control self-traveling of the work vehicle 100. During travel of the work vehicle 100, based on the sensor data that is output from the LiDAR sensor (s) 140, the controller can consecutively generate an obstacle map indicating a distribution of objects existing around the work vehicle 100. The controller may generate an environment map by joining together obstacle maps with the use of an algorithm such as SLAM (Simultaneous Localization and Mapping), for example, during self-traveling. The controller can perform estimation of the position and orientation of the work vehicle 100 (i.e., localization) by matching the sensor data against the environment map.

In an environment in which trees or crops are distributed with a high density, e.g., vineyards or other orchards or forests, leaves thriving in upper portions of the trees create canopies, each of which serves as an obstacle or a multiple reflector against radio waves from a satellite. Such an environment may hinder accurate positioning using a GNSS in some cases. In an environment where GNSS cannot be used, SLAM is used, where localization and map generation simultaneously take place. Use of SLAM allows the work vehicle 100 to travel automatically in an environment with a multitude of trees.

The plurality of obstacle sensors 130 shown in FIG. 1 are provided at the front and the rear of the cabin 105. The obstacle sensors 130 may be disposed at other positions. For example, one or more obstacle sensors 130 may be disposed at any position at the sides, the front, or the rear of the vehicle body 101. The obstacle sensors 130 may include, for example, laser scanners or ultrasonic sonars. The obstacle sensors 130 may be used to detect obstacles in the surroundings during self-traveling to cause the work vehicle 100 to halt or detour around the obstacles.

The work vehicle 100 further includes a GNSS unit 110. GNSS is a collective term for satellite positioning systems such as the GPS (Global Positioning System), QZSS (Quasi-Zenith Satellite System, e.g., MICHIBIKI), GLONASS, Galileo, and BeiDou. A GNSS unit 110 receives satellite signals (also referred to as GNSS signals) that are transmitted from a plurality of GNSS satellites, and performs positioning based on the satellite signals. Although the GNSS unit 110 in the present example embodiment is disposed above the cabin 105, it may be disposed at any other position. The GNSS unit 110 includes an antenna to receive signals from the GNSS satellites, and a processing circuit. The work vehicle 100 in the present example embodiment is used in environments where multiple trees grow to make it difficult to use a GNSS, e.g., a vineyard. In such environments, the LiDAR sensor(s) 140 is mainly used in positioning. However, in an environment where it is possible to receive GNSS signals, positioning may be performed by using the GNSS unit 110. By combining the positioning based on the LiDAR sensor(s) 140 and the positioning based on the GNSS unit 110, the stability or accuracy of positioning can be improved.

The GNSS unit 110 may include an inertial measurement unit (IMU). Signals from the IMU can be used to complement position data. The IMU can measure a tilt or a small motion of the work vehicle 100. The data acquired by the IMU can be used to complement the position data based on the satellite signals, so as to improve the performance of positioning.

The prime mover 102 may be a diesel engine, for example. Instead of a diesel engine, an electric motor may be used. The transmission 103 can change the propulsion and the moving speed of the work vehicle 100 through a speed changing mechanism. The transmission 103 can also switch between forward travel and backward travel of the work vehicle 100.

The steering device 106 includes a steering wheel, a steering shaft connected to the steering wheel, and a power steering device to assist in the steering by the steering wheel. The front wheels 104F are the wheels responsible for steering, such that changing their steering angle (also referred to as “angle of turn”) can cause a change in the traveling direction of the work vehicle 100. The steering angle of the front wheels 104F can be changed by manipulating the steering wheel. The power steering device includes a hydraulic device or an electric motor to supply an assisting force for changing the steering angle of the front wheels 104F. When automatic steering is performed, under the control of the controller disposed in the work vehicle 100, the steering angle may be automatically adjusted by the power of the hydraulic device or the electric motor.

A linkage device 108 is provided at the rear of the vehicle body 101. The linkage device 108 includes, e.g., a three-point linkage (also referred to as a “three-point link” or a “three-point hitch”), a PTO (Power Take Off) shaft, a universal joint, and a communication cable. The linkage device 108 allows the implement 300 to be attached to, or detached from, the work vehicle 100. The linkage device 108 is able to raise or lower the three-point link with a hydraulic device, for example, thus changing the position or attitude of the implement 300. Moreover, motive power can be sent from the work vehicle 100 to the implement 300 via the universal joint. While towing the implement 300, the work vehicle 100 allows the implement 300 to perform a predetermined task. The linkage device may be provided at the front portion of the vehicle body 101. In that case, the implement can be connected at the front portion of the work vehicle 100.

Although the implement 300 shown in FIG. 1 is a sprayer to spray a chemical agent onto a crop, the implement 300 is not limited to a sprayer. For example, any arbitrary task device such as a mower, a seeder, a spreader, a rake, a baler, a harvester, a plow, a harrow, or a rotary tiller may be connected to the work vehicle 100 for use.

The work vehicle 100 shown in FIG. 1 can be driven by human driving. Alternatively, the work vehicle 100 may only support unmanned driving. In that case, component elements which are only required for human driving, e.g., the cabin 105, the steering device 106, and the driver's seat 107 do not need to be provided in the work vehicle 100. An unmanned work vehicle 100 can travel via autonomous travel, or by remote manipulation by a user.

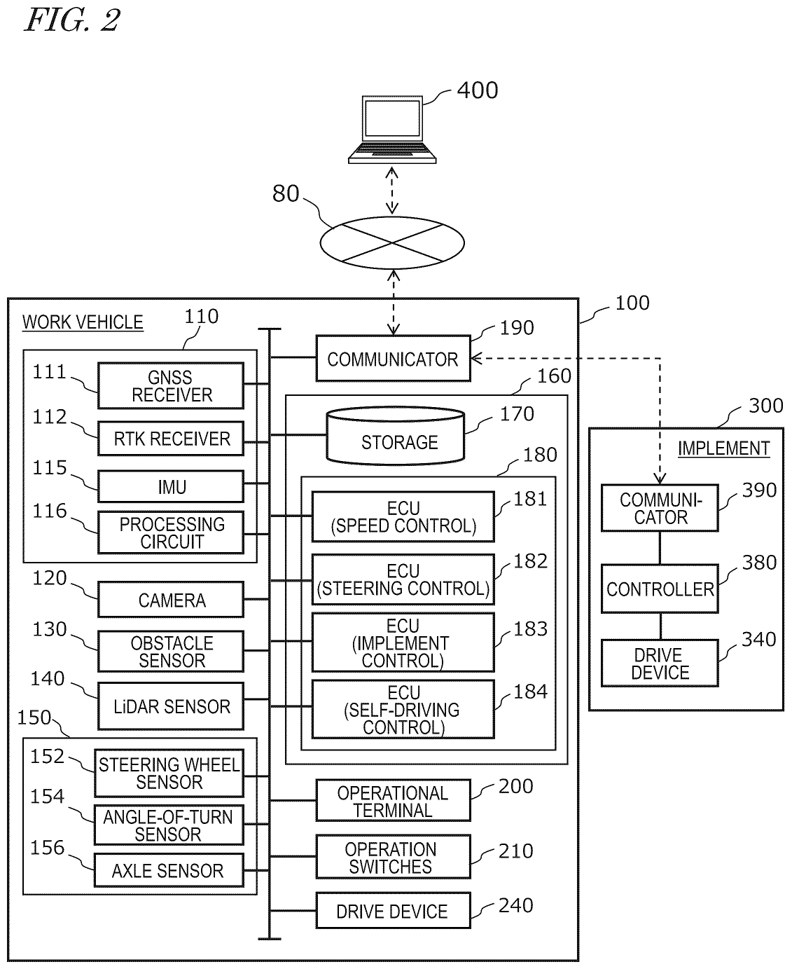

FIG. 2 is a block diagram showing an example configuration of the work vehicle 100 and the implement 300. The work vehicle 100 and the implement 300 can communicate with each other via a communication cable that is included in the linkage device 108. The work vehicle 100 is able to communicate with a terminal device 400 for remote monitoring via a network 80. The terminal device 400 may be any arbitrary computer, e.g., a personal computer (PC), a laptop computer, a tablet computer, or a smartphone, for example. Via the network 80, the work vehicle 100 may communicate with a server that keeps agricultural work under management.

In addition to the GNSS unit 110, the camera(s) 120, the obstacle sensors 130, the LiDAR sensor(s) 140, and the operational terminal 200, the work vehicle 100 in the example of FIG. 2 includes sensors 150 to detect the operating status of the work vehicle 100, a travel control system 160, a communicator 190, operation switches 210, and a drive device 240. These component elements are communicably connected to one another via a bus.

The GNSS unit 110 includes a GNSS receiver 111, an RTK receiver 112, an inertial measurement unit (IMU) 115, and a processing circuit 116. The sensors 150 include a steering wheel sensor 152, an steering angle sensor 154, and a wheel axis sensor 156. The travel control system 160 includes a storage device 170 and a controller 180. The controller 180 is configured or programmed to include a plurality of electronic control units (ECU) 181 to 184. The implement 300 includes a drive device 340, a controller 380, and a communicator 390. Note that FIG. 2 shows component elements which are relatively closely related to the operations of self-driving by the work vehicle 100, while other components are omitted from illustration. The travel control system 160 may be referred to as a controller.

The GNSS receiver 111 in the GNSS unit 110 receives satellite signals transmitted from the plurality of GNSS satellites and generates GNSS data based on the satellite signals. The GNSS data is generated in a predetermined format such as, for example, the NMEA-0183 format. The GNSS data may include, for example, the ID number, the angle of elevation, the azimuth angle, and a value representing the reception intensity of each of the satellites from which the satellite signals are received.

The GNSS unit 110 may perform positioning of the work vehicle 100 by utilizing an RTK (Real Time Kinematic)-GNSS. In the positioning based on the RTK-GNSS, not only satellite signals transmitted from a plurality of GNSS satellites, but also a correction signal that is transmitted from a reference station is used. The reference station may be disposed near the work area where the work vehicle 100 performs tasked travel (e.g., at a position within 10 km of the work vehicle 100). The reference station generates a correction signal of, for example, an RTCM format based on the satellite signals received from the plurality of GNSS satellites, and transmits the correction signal to the GNSS unit 110. The RTK receiver 112, which includes an antenna and a modem, receives the correction signal transmitted from the reference station. Based on the correction signal, the processing circuit 116 of the GNSS unit 110 corrects the results of the positioning performed by the GNSS receiver 111. Use of the RTK-GNSS enables positioning with an accuracy on the order of several centimeters of errors, for example. Positional information including latitude, longitude, and altitude information is acquired through the highly accurate positioning by the RTK-GNSS. The GNSS unit 110 calculates the position of the work vehicle 100 as frequently as, for example, one to ten times per second. Note that the positioning method is not limited to being performed by using an RTK-GNSS, any arbitrary positioning method (e.g., an interferometric positioning method or a relative positioning method) that provides positional information with the necessary accuracy can be used. For example, positioning may be performed by utilizing a VRS (Virtual Reference Station) or a DGPS (Differential Global Positioning System).

The GNSS unit 110 according to the present example embodiment further includes the IMU 115. The IMU 115 may include a 3-axis accelerometer and a 3-axis gyroscope. The IMU 115 may include a direction sensor such as a 3-axis geomagnetic sensor. The IMU 115 functions as a motion sensor which can output signals representing parameters such as acceleration, velocity, displacement, and attitude of the work vehicle 100. Based not only on the satellite signals and the correction signal but also on a signal that is output from the IMU 115, the processing circuit 116 can estimate the position and orientation of the work vehicle 100 with a higher accuracy. The signal that is output from the IMU 115 may be used for the correction or complementation of the position that is calculated based on the satellite signals and the correction signal. The IMU 115 outputs a signal more frequently than the GNSS receiver 111. For example, the IMU 115 outputs a signal as frequently as approximately several ten times to several thousand times per second. Utilizing this signal that is output highly frequently, the processing circuit 116 allows the position and orientation of the work vehicle 100 to be measured more frequently (e.g., about 10 Hz or above). Instead of the IMU 115, a 3-axis accelerometer and a 3-axis gyroscope may be separately provided. The IMU 115 may be provided as a separate device from the GNSS unit 110.

The cameras 120 are imagers that image the surrounding environment of the work vehicle 100. Each camera 120 includes an image sensor such as a CCD (Charge Coupled Device) or a CMOS (Complementary Metal Oxide Semiconductor), for example. In addition, each camera 120 may include an optical system including one or more lenses and a signal processing circuit. During travel of the work vehicle 100, the cameras 120 image the surrounding environment of the work vehicle 100, and generate image (e.g., motion picture) data. The cameras 120 are able to capture motion pictures at a frame rate of 3 frames/second (fps: frames per second) or greater, for example. The images generated by the cameras 120 may be used by a remote supervisor to check the surrounding environment of the work vehicle 100 with the terminal device 400, for example. The images generated by the cameras 120 may also be used for the purpose of positioning or detection of obstacles. As shown in FIG. 1, the plurality of cameras 120 may be provided at different positions on the work vehicle 100, or a single camera 120 may be provided. A visible camera(s) to generate visible images and an infrared camera(s) to generate infrared images may be separately provided. Both of a visible camera(s) and an infrared camera(s) may be provided as a camera(s) to generate images for monitoring purposes. The infrared camera(s) may also be used for detection of obstacles at nighttime.

An obstacle sensor 130 detects objects around the work vehicle 100. The obstacle sensor 130 may include a laser scanner or an ultrasonic sonar, for example. When an object exists at a position closer to the obstacle sensor 130 than a predetermined distance, the obstacle sensor 130 outputs a signal indicating the presence of an obstacle. A plurality of obstacle sensors 130 may be provided at different positions of the work vehicle 100. For example, a plurality of laser scanners and a plurality of ultrasonic sonars may be disposed at different positions of the work vehicle 100. Providing a multitude of obstacle sensors 130 can reduce blind spots in monitoring obstacles around the work vehicle 100.

The steering wheel sensor 152 measures the angle of rotation of the steering wheel of the work vehicle 100. The steering angle sensor 154 measures the steering angle of the front wheels 104F, which are the wheels responsible for steering. Measurement values by the steering wheel sensor 152 and the steering angle sensor 154 may be used for steering control by the controller 180.

The wheel axis sensor 156 measures the rotational speed, i.e., the number of revolutions per unit time, of a wheel axis that is connected to the wheels 104. The wheel axis sensor 156 may be a sensor including a magnetoresistive element (MR), a Hall generator, or an electromagnetic pickup, for example. The wheel axis sensor 156 outputs a numerical value indicating the number of revolutions per minute (unit: rpm) of the wheel axis, for example. The wheel axis sensor 156 is used to measure the speed of the work vehicle 100. Measurement values from the wheel axis sensor 156 can be utilized for the speed control by the controller 180.

The drive device 240 includes various types of devices required to cause the work vehicle 100 to travel and to drive the implement 300, for example, the prime mover 102, the transmission 103, the steering device 106, the linkage device 108 and the like described above. The prime mover 102 may include an internal combustion engine such as, for example, a diesel engine. The drive device 240 may include an electric motor for traction instead of, or in addition to, the internal combustion engine.

The storage device 170 includes one or more storage media such as a flash memory or a magnetic disc. The storage device 170 stores various data that is generated by the GNSS unit 110, the camera(s) 120, the obstacle sensor(s) 130, the LiDAR sensor(s) 140, the sensors 150, and the controller 180. The data that is stored by the storage device 170 may include an environment map of the environment where the work vehicle 100 travels, an obstacle map that is consecutively generated during travel, and path data for self-driving. The storage device 170 also stores a computer program(s) to cause each of the ECUs in the controller 180 to perform various operations described below. Such a computer program(s) may be provided to the work vehicle 100 via a storage medium (e.g., a semiconductor memory, an optical disc, etc.) or through telecommunication lines (e.g., the Internet). Such a computer program(s) may be marketed as commercial software.

The controller 180 is configured or programmed to include the plurality of ECUs. The plurality of ECUs include, for example, the ECU 181 for speed control, the ECU 182 for steering control, the ECU 183 for implement control, and the ECU 184 for self-driving control.

The ECU 181 controls the prime mover 102, the transmission 103, and brakes included in the drive device 240, thus controlling the speed of the work vehicle 100.

The ECU 182 controls the hydraulic device or the electric motor included in the steering device 106 based on a measurement value of the steering wheel sensor 152, thus controlling the steering of the work vehicle 100.

In order to cause the implement 300 to perform a desired operation, the ECU 183 controls the operations of the three-point link, the PTO shaft and the like that are included in the linkage device 108. Also, the ECU 183 generates a signal to control the operation of the implement 300, and transmits this signal from the communicator 190 to the implement 300.

Based on data output from the GNSS unit 110, the camera(s) 120, the obstacle sensor(s) 130, the LiDAR sensor(s) 140, and the sensors 150, the ECU 184 performs computation and control for achieving self-driving. For example, the ECU 184 estimates the position of the work vehicle 100 based on the data output from at least one of the GNSS unit 110, the camera (s) 120, and the LiDAR sensor(s) 140. In a situation where a sufficiently high reception intensity exists for the satellite signals from the GNSS satellites, the ECU 184 may determine the position of the work vehicle 100 based only on the data output from the GNSS unit 110. On the other hand, in an environment where obstructions, such as trees, that may hinder reception of the satellite signals exist around the work vehicle 100, e.g., an orchard, the ECU 184 estimates the position of the work vehicle 100 by using the data output from the LiDAR sensor(s) 140 or the camera(s) 120. During self-driving, the ECU 184 performs computation necessary for the work vehicle 100 to travel along a target path, based on the estimated position of the work vehicle 100. The ECU 184 sends the ECU 181 a command to change the speed, and sends the ECU 182 a command to change the steering angle. In response to the command to change the speed, the ECU 181 controls the prime mover 102, the transmission 103, or the brakes to change the speed of the work vehicle 100. In response to the command to change the steering angle, the ECU 182 controls the steering device 106 to change the steering angle.

Through the actions of these ECUs, the controller 180 realizes self-traveling. During self-traveling, the controller 180 is configured or programmed to control the drive device 240 based on the measured or estimated position of the work vehicle 100 and on the consecutively-generated target path. As a result, the controller 180 can cause the work vehicle 100 to travel along the target path.

The plurality of ECUs included in the controller 180 can communicate with one another in accordance with a vehicle bus standard such as, for example, a CAN (Controller Area Network). Instead of a CAN, faster communication methods such as Automotive Ethernet (registered trademark) may be used. Although the ECUs 181 to 184 are illustrated as individual blocks in FIG. 2, the function of each of the ECU 181 to 184 may be implemented by a plurality of ECUs. Alternatively, an onboard computer that integrates the functions of at least some of the ECUs 181 to 184 may be provided. The controller 180 may include ECUs other than the ECUs 181 to 184, and any number of ECUs may be provided in accordance with functionality. Each ECU includes a processing circuit including one or more processors and one or more memories. Such a memory(es) may have stored therein a computer program to cause the processor(s) to perform various operation described below.

The communicator 190 is a device including a circuit communicating with the implement 300 and the terminal device 400. The communicator 190 includes circuitry to perform exchanges of signals complying with an ISOBUS standard such as ISOBUS-TIM, for example, between itself and the communicator 390 of the implement 300. This allows the implement 300 to perform a desired operation, or allows information to be acquired from the implement 300. The communicator 190 may further include an antenna and a communication circuit to exchange signals via the network 80 with the respective communicators of the terminal device 400. The network 80 may include a 3G, 4G, 5G, or any other cellular mobile communications network and the Internet, for example. The communicator 190 may have a function of communicating with a mobile terminal that is used by a supervisor who is situated near the work vehicle 100. With such a mobile terminal, communication may be performed based on any arbitrary wireless communication standard, e.g., Wi-Fi (registered trademark), 3G, 4G, 5G or any other cellular mobile communication standard, or Bluetooth (registered trademark).

The operational terminal 200 is a terminal for the user to perform a manipulation related to the travel of the work vehicle 100 and the operation of the implement 300, and is also referred to as a virtual terminal (VT). The operational terminal 200 may include a display device such as a touch screen panel, and/or one or more buttons. The display device may be a display such as a liquid crystal display or an organic light-emitting diode (OLED) display, for example. By manipulating the operational terminal 200, the user can perform various manipulations, such as, for example, switching ON/OFF the self-driving mode, and switching ON/OFF the implement 300. At least a portion of these manipulations may also be realized by manipulating the operation switches 210. The operational terminal 200 may be configured so as to be detachable from the work vehicle 100. A user who is at a remote place from the work vehicle 100 may manipulate the detached operational terminal 200 to control the operation of the work vehicle 100.

The drive device 340 in the implement 300 shown in FIG. 2 performs operations necessary for the implement 300 to perform predetermined work. The drive device 340 includes a device suitable for uses of the implement 300, for example, a hydraulic device, an electric motor, a pump or the like. The controller 380 controls the operation of the drive device 340. In response to a signal that is transmitted from the work vehicle 100 via the communicator 390, the controller 380 causes the drive device 340 to perform various operations. Moreover, a signal that is in accordance with the state of the implement 300 can be transmitted from the communicator 390 to the work vehicle 100.

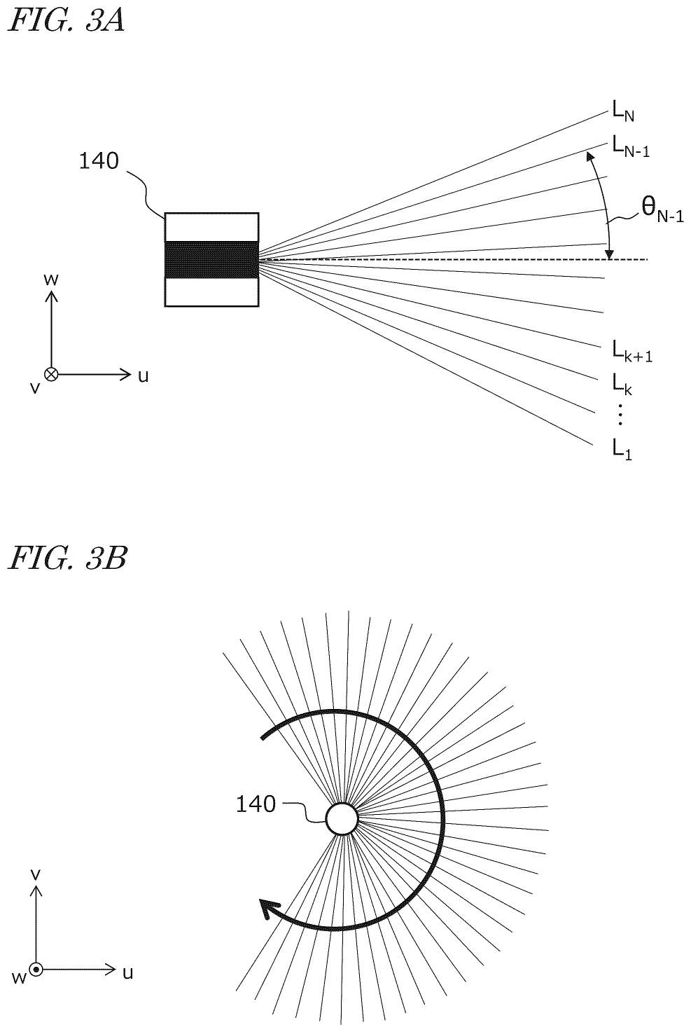

Next, with reference to FIG. 3A and FIG. 3B, an exemplary configuration of the LiDAR sensor 140 will be described. The LiDAR sensor 140 in the present example embodiment is a scan-type sensor capable of acquiring information on the distance distribution of objects within a space by laser beam scanning. FIG. 3A is a schematic diagram of the LiDAR sensor 140 as viewed in a lateral direction of the work vehicle 100. FIG. 3B is a schematic diagram of the LiDAR sensor 140 as viewed from vertically above. In FIG. 3A and FIG. 3B are shown three axes u, v and w in a sensor coordinate system that is fixed to the LiDAR sensor 140, which are orthogonal to one another. In FIG. 3A and FIG. 3B, straight lines extending radially schematically represent the center axes (or traveling directions) of laser beams emitted from the LiDAR sensor 140. Although each laser beam is collimated into parallel light, it has an angle of spread of several milliradians (e.g., 0.1 to 0.2 degrees). Therefore, the cross-sectional size (spot diameter) of each laser beam increases in proportion to distance from the LiDAR sensor 140. For example, a light spot with a diameter of several centimeters may be formed 20 meters away from the LiDAR sensor 140. In the figure, for simplicity, the spread of each laser beam is ignored, and only the center axis of the laser beam is illustrated.

The LiDAR sensor 140 in the example of FIG. 3A is able to emit laser beams from a plurality of laser light sources that are arranged along the vertical direction, respectively at different angles of elevation. An angle of elevation is defined as an angle relative to the uv plane. In this example, the uv plane is essentially parallel to the horizontal plane. Note that, when the ground surface is inclined with respect to the horizontal plane, the uv plane and the horizontal plane will intersect. FIG. 3A illustrates N laser beams L₁, . . . , L_{N} being emitted. Herein, “N” is an integer of 1 or greater, and may be e.g. 10 or greater, and 64, or even 100 or greater, for high-performance models. Among the plurality of laser beams, a k^{th} laser beam from the bottom has an angle of elevation θₖ. As one example, FIG. 3A shows an angle of elevation θ_{N-1} of an N−1^{th} laser beam. The angle of elevation of any laser beam going upward from the uv plane is defined as a “positive angle of elevation”, whereas the angle of elevation of any laser beam going downward from the uv plane is defined as a “negative angle of elevation”.

A LiDAR sensor having an N of 1 may be referred to as a “two-dimensional LiDAR”, while a LiDAR sensor having an N of 2 or more may be referred to as a “three-dimensional LiDAR”. When N is 2 or more, the angle made by the first laser beam and an N^{th} laser beam is referred to as the “vertical viewing angle”. The vertical viewing angle may be set in a range from about 20° to 60°, for example.

As shown in FIG. 3B, the LiDAR sensor 140 is able to change the outgoing directions (e.g., azimuth angles) of laser beams. FIG. 3B shows the outgoing directions of the plurality of laser beams shown in FIG. 3A as rotating around a rotation axis that is parallel to the w axis. The range of the outgoing directions (azimuth angles) of the laser beams may be 360°, or an angle range that is smaller than 360° (e.g., 210° or 270°). The range of azimuth angles of the outgoing directions of laser beams is referred to as the “horizontal viewing angle”. The horizontal viewing angle may be set in a range from about 90° to 360°, for example. While rotating the outgoing directions of laser beams around a rotation axis that is parallel to the w axis, the LiDAR sensor 140 sequentially emits pulsed laser light (laser pulses) in directions of different azimuth angles. Thus, with pulsed laser light emitted at different angles of elevation and different azimuth angles, it is possible to measure the distance to each reflection point. Each reflection point corresponds to each individual point included in the point cloud data. The operation of measuring the distance to each reflection point while the azimuth angles of laser beams make one rotation around the rotation axis is referred to as one scan. Sensor data that is obtained through one scan includes data that is measured for every layer that is associated with a certain angle of elevation as shown in FIG. 3A. Therefore, the greater the number of layers is, the greater the number of points in the point cloud that are obtained through one scan for the same environment. The LiDAR sensor 140 repeats scan operations with a frequency of about 1 to 20 times per second, for example. During one scan operation, 100,000 or more pulses of laser light may be emitted in different directions, for example.

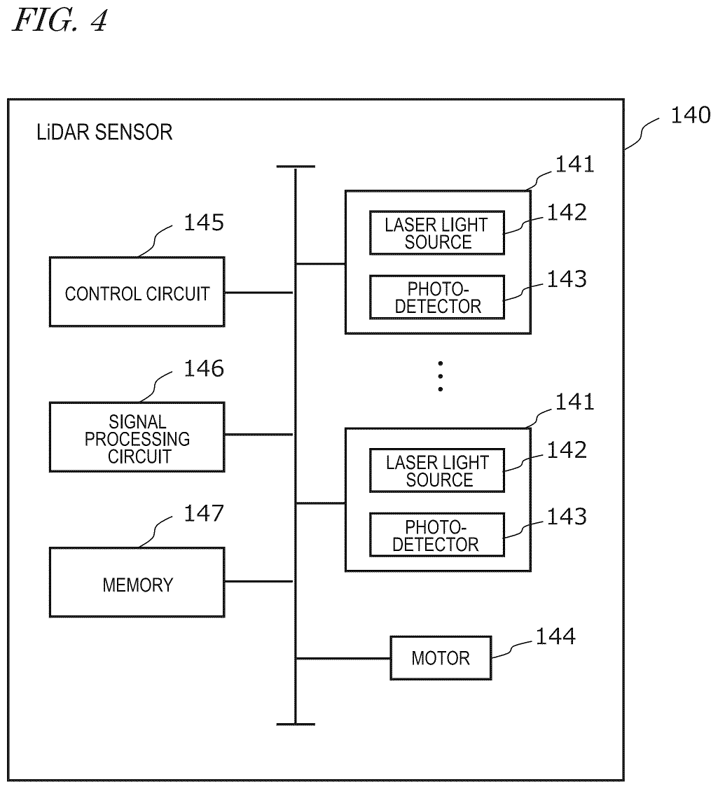

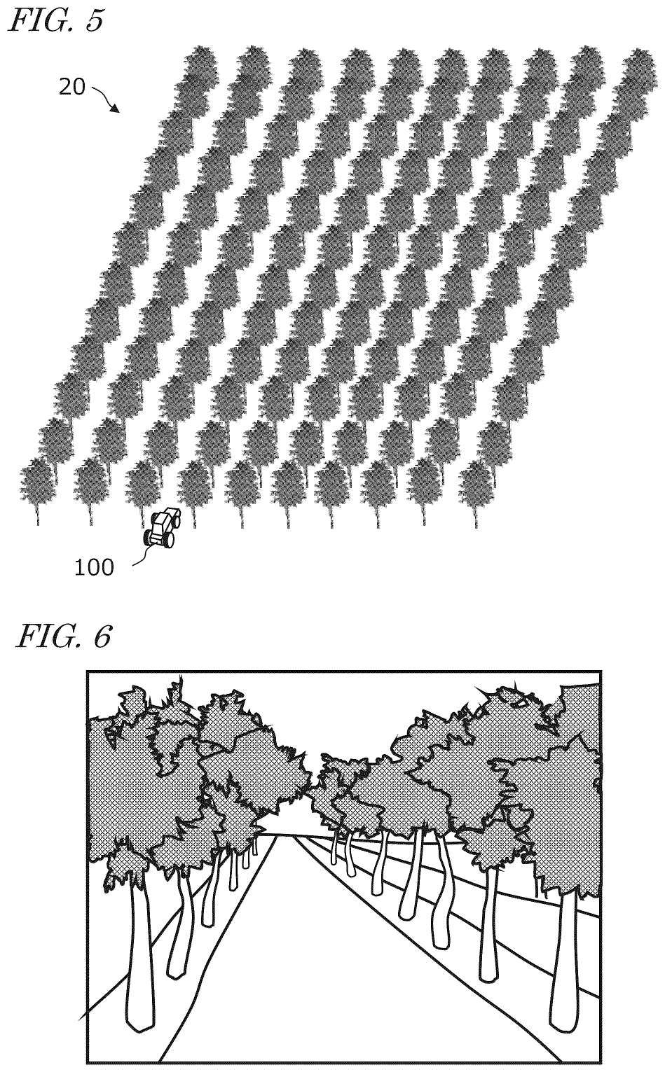

FIG. 4 is a block diagram showing an exemplary schematic configuration of the LiDAR sensor 140. As shown in FIG. 4, the LiDAR sensor 140 includes a plurality of laser units 141, an electric motor 144, a control circuit 145, a signal processing circuit 146, and a memory 147. Each laser unit 141 includes a laser light source 142 and a photodetector 143. Each laser unit 141 may include optics such as a lens(es) and a mirror(s), but they are omitted from illustration. By rotating a mirror that is placed on the optical path of a laser beam emitted from each laser light source 142, for example, the motor 144 changes the direction of the laser beam emitted from the respective laser light source 142.

Each laser light source 142 includes a laser diode, and emits a pulsed laser beam of a predetermined wavelength in response to a command from the control circuit 145. The wavelength of the laser beam may be a wavelength that is included in the near-infrared wavelength region (approximately 700 nm to 2.5 μm), for example. The wavelength used depends on the material of the photoelectric conversion element used for the photodetector 143. In the case where silicon (Si) is used as the material of the photoelectric conversion element, for example, a wavelength around 900 nm may be mainly used. In the case where indium gallium arsenide (InGaAs) is used as the material of the photoelectric conversion element, a wavelength of not less than 1000 nm and not more than 1650 nm may be used, for example. Note that the wavelength of the laser beam is not limited to the near-infrared wavelength region. In applications where influences of ambient light are not a problem (e.g., for nighttime use), a wavelength included in the visible region (approximately 400 nm to 700 nm) may be used. Depending on the application, the ultraviolet wavelength region may also be used. In the present specification, any radiation in the ultraviolet, visible light, and infrared wavelength regions in general is referred to as “light”.

Each photodetector 143 detects laser pulses that are emitted from the laser light source 142 and reflected or scattered by an object. The photodetector 143 includes a photoelectric conversion element such as an avalanche photodiode (APD), for example. The photodetector 143 outputs an electrical signal which is in accordance with the amount of received light.

In response to a command from the control circuit 145, the motor 144 rotates the mirror that is placed on the optical path of a laser beam emitted from each laser light source 142. This realizes a scan operation that changes the outgoing directions of laser beams.

The control circuit 145 controls emission of laser pulses by the laser light sources 142, detection of reflection pulses by the photodetectors 143, and rotational operation by the motor 144. The control circuit 145 can be implemented by a circuit that includes a processor and a memory, e.g., a microcontroller unit (MCU), for example.

The signal processing circuit 146 is a circuit to perform computations based on signals that are output from the photodetectors 143. The signal processing circuit 146 uses a ToF (Time of Flight) technique to calculate a distance to an object that has reflected a laser pulse emitted from a laser light source 142, for example. ToF techniques include direct ToF and indirect ToF. Under direct ToF, the time from the emission of a laser pulse from the laser light source 142 until reflected light is received by the photodetector 143 is directly measured to calculate the distance to the reflection point. Under indirect ToF, a plurality of exposure periods are set in the photodetector 143, and the distance to each reflection point is calculated based on a ratio of light amounts detected in the respective exposure periods. Either the direct ToF or indirect ToF method may be used. The signal processing circuit 146 generates and outputs sensor data indicating the distance to each reflection point and the direction of that reflection point, for example. Furthermore, the signal processing circuit 146 may calculate coordinates (u,v) or (u,v,w) in the sensor coordinate system based on the distance to each reflection point and the direction of that reflection point, and include these in the sensor data for output.

Although the control circuit 145 and the signal processing circuit 146 are two separate circuits in the example of FIG. 4, they may be implemented as a single circuit.

The memory 147 is a storage medium to store data that is generated by the control circuit 145 and the signal processing circuit 146. For example, the memory 147 stores data that associates the emission timing of a laser pulse emitted from each laser unit 141, the outgoing direction, the reflected light intensity, the distance to the reflection point, and the coordinates (u,v) or (u,v,w) in the sensor coordinate system. Such data is generated each time a laser pulse is emitted, and recorded to the memory 147. The control circuit 145 outputs such data with a predetermined cycle (e.g., the length of time required to emit a predetermined number of pulses, a half scan period, or one scan period). The output data is recorded in the storage device 170 of the work vehicle 100.

The LiDAR sensor 140 outputs sensor data with a frequency of about 1 to 20 times per second, for example. This sensor data may include the coordinates of multiple points expressed by the sensor coordinate system, and time stamp information. The sensor data may include the information of distance and direction toward each reflection point but not include coordinate information. In such cases, the controller 180 performs conversion from the distance and direction information into coordinate information.

Note that the method of distance measurement is not limited to the ToF technique, but other methods such as the FMCW (Frequency Modulated Continuous Wave) technique may also be used. In the FMCW technique, light whose frequency is linearly changed is emitted, and distance is calculated based on the frequency of beats that occur due to interferences between the emitted light and the reflected light.

As described above, the LiDAR sensor(s) 140 according to the present example embodiment may be scan-type sensors, which acquire information on the distance distribution of objects in space by scanning a laser beam. However, the LiDAR sensors 140 are not limited to scan-type sensors. For example, the LiDAR sensor(s) 140 may be flash-type sensors, which acquire information on the distance distribution of objects in space by using light diffused over a wide area. A scan-type LiDAR sensor uses a higher intensity light than does a flash-type LiDAR sensor, and thus can acquire distance information at a greater distance. On the other hand, flash-type LiDAR sensors are suitable for applications that do not require intense light because they are simple in structure and can be manufactured at low cost.

Next, an operation of the work vehicle 100 will be described.

FIG. 5 is a diagram schematically showing an example of an environment in which the work vehicle 100 travels. FIG. 6 is a perspective view schematically showing an example of the surrounding environment of the work vehicle 100. In this example, while traveling between rows of trees 20 (i.e., crop rows) in an orchard such as a vineyard, the work vehicle 100 uses the implement 300 to perform predetermined tasks (e.g., spreading chemical agents, mowing, preventive pest control, or the like). The sky over an orchard is obstructed by branches and leaves, which may hinder self-traveling using a GNSS. In an environment where a GNSS cannot be used, it may be conceivable to travel while performing localization through matching between an environment map that is created in advance and the sensor data. However, in a field such as an orchard, the outer shapes of the leaves of trees or other crops or hedges may change significantly with seasons, thus making it difficult to continue using an environment map that is created in advance. Moreover, in a conventional self-driving agricultural machine, information such as positions of crop rows, shape of the field, and positions of headland areas is set in advance, and a path for self-traveling is generated based on such information. In a vast field, however, it is considerable work to set the positions of crop rows in advance.

Therefore, the controller 180 according to the present example embodiment is configured or programmed to detect two crop rows existing on opposite sides of the work vehicle 100 based on sensor data that is output from the LiDAR sensor(s) 140, and cause the work vehicle 100 to travel along a path between the two crop rows.

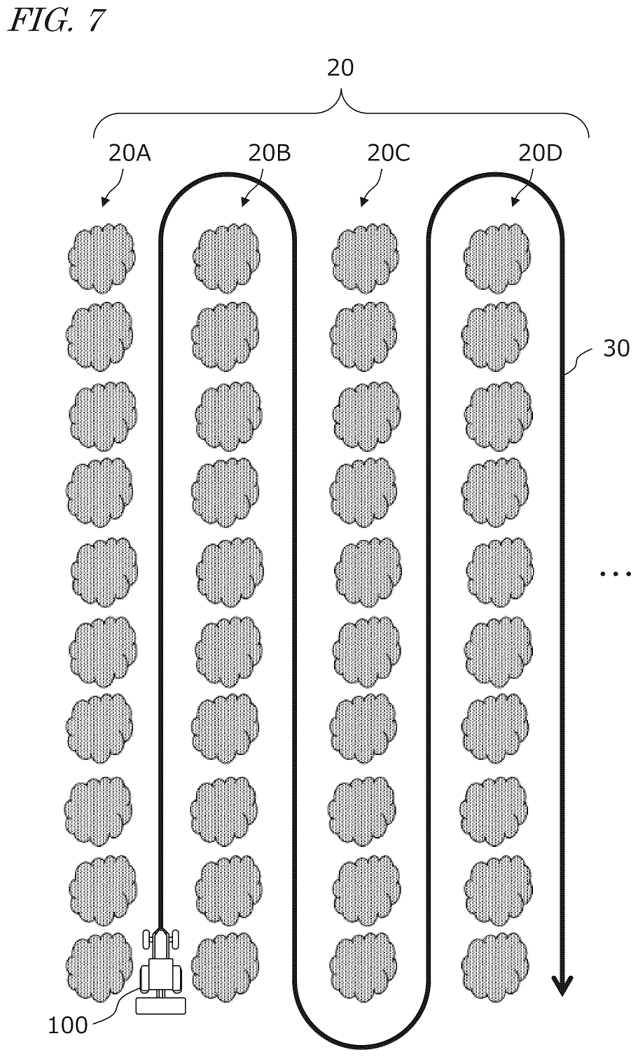

FIG. 7 is a diagram showing schematically an example of a travel path 30 of the work vehicle 100. The work vehicle 100 travels among rows of trees 20 along the path 30 as illustrated. Although FIG. 7 illustrates any line segment included in the path 30 to be a straight line, the path along which the work vehicle 100 actually travels may include meandering portions. Now, the plurality of rows of trees 20 are sequentially designated as a first row of trees 20A, a second row of trees 20B, a third row of trees 20C, a fourth row of trees 20D, . . . , from the end. In the example of FIG. 7, the work vehicle 100 first travels between the first row of trees 20A and the second row of trees 20B, and upon completing this travel, turns right to travel between the second row of trees 20B and the third row of trees 20C in the opposite direction. Once the travel between the second row of trees 20B and the third row of trees 20C is completed, it further turns left to travel between the third row of trees 20C and the fourth row of trees 20D. Thereafter, by repeating a similar operation, it travels to the final end of the path 30, which will be in between the last two rows of trees.

At timings when the GNSS unit 110 is able to receive a GNSS signal, positioning may be conducted based on the GNSS signal. For example, at any timing of turning around along the path 30 illustrated in either FIG. 7, no leaves exist to obstruct the GNSS signal, and therefore positioning based on the GNSS signal is possible.

The controller 180 of the work vehicle 100 according to the present example embodiment operates in an inter-row travel mode of causing the work vehicle 100 to travel along a path between two adjacent rows of trees, and a turning travel mode of causing the work vehicle 100 to turn in a headland. A headland is a region between an end of each row of trees and the boundary of the orchard. In the inter-row travel mode, based on the sensor data being consecutively output from the LiDAR sensor(s) 140, the controller 180 detects two rows of trees existing on opposite sides of the work vehicle 100, and while setting a target path in between the two rows of trees, causes the work vehicle 100 to travel along the target path. During turning, based on the sensor data being consecutively output from the LiDAR sensor(s) 140, the controller 180 causes the work vehicle 100 to travel along the turning path, while performing localization for the work vehicle 100. In the turning travel mode, the controller 180 may utilize not only the sensor data but also utilize a signal that is output from the GNSS receiver 111 and/or a signal that is output from the IMU 115 to perform positioning. Once completing the turn, the work vehicle 100 again transitions to the inter-row travel mode. Thereafter, similar operations are repeated until the last instance of inter-row travel is finished. Through the above operation, self-traveling between rows of trees 20 is achieved. The above control is mainly realized by the ECU 184 of the controller 180 (FIG. 2).

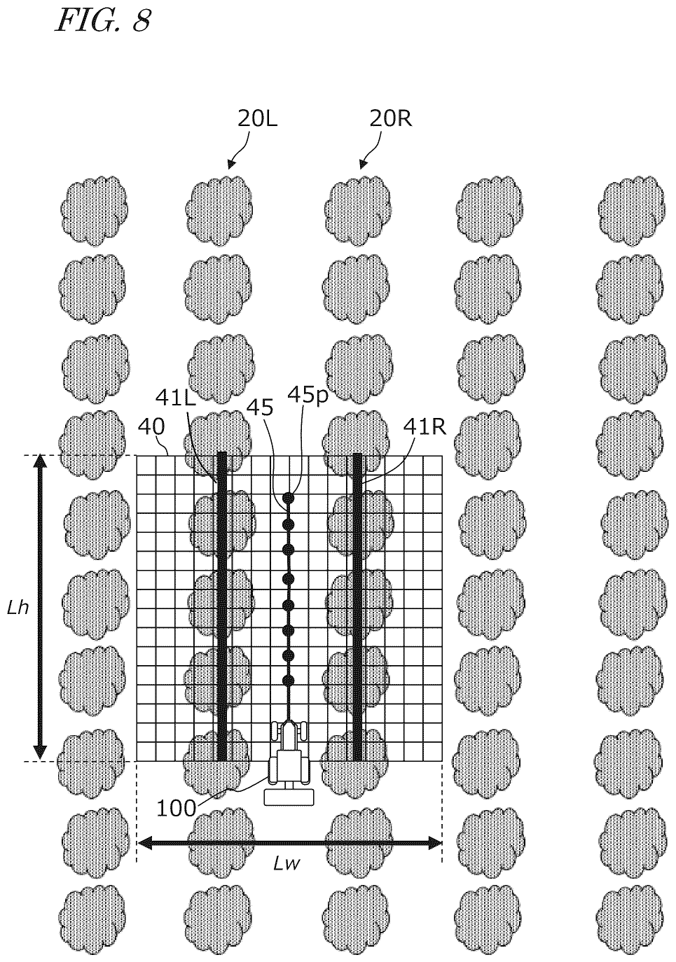

FIG. 8 is a diagram for describing a method of travel control for the work vehicle 100 in the inter-row travel mode. While traveling between two adjacent rows of trees 20R and 20L, the work vehicle 100 scans the surrounding environment with a laser beam, by using the LiDAR sensor(s) 140. As a result, data indicating a distance distribution of objects existing in the environment is acquired. The data indicating the distance distribution is converted into two-dimensional or three-dimensional point cloud data, for example, and output as sensor data. During travel of the work vehicle 100, the controller 180 consecutively generates the obstacle map 40 based on the sensor data that is output from the LiDAR sensor(s) 140. The obstacle map 40 represents a distribution of objects in a vehicle coordinate system that is fixed to the work vehicle 100. The vehicle coordinate system is a coordinate system that moves together with the work vehicle 100, and is also referred to as a sensor coordinate system or a local coordinate system.

The obstacle map 40 has a predetermined length Lh and width Lw. The length Lh is a longitudinal size corresponding to the traveling direction of the work vehicle 100. The width Lw is a lateral size that is perpendicular to both of the traveling direction of the work vehicle 100 and the vertical direction.

In the example shown in FIG. 8, the controller 180 detects two rows of trees 20R and 20L existing on opposite sides of the work vehicle 100, based on the obstacle map 40. Specifically, the controller 180 subjects the obstacle map 40 to a Hough transform or other processing to derive approximate straight lines (line segments) 41R and 41L for the rows of trees 20R and 20L. The controller 180 sets a target path 45 between the approximate straight lines 41R and 41L (e.g., in the middle). In a case where the plurality of trees in the rows of trees 20R and 20L are distributed in curved shapes, the controller 180 may derive approximate curves rather than approximate straight lines, and set the target path 45 between such approximate curves. The target path 45 may be set in a relatively short range beginning at the position of the work vehicle 100 (e.g., a range on the order of 5 to 30 meters).

The target path 45 may be defined by a plurality of waypoints 45p. Each waypoint 45p may include information of the position and orientation (or velocity) of the point to be passed by the work vehicle 100. The interval between waypoints 45p may be set to a value of, e.g., several ten centimeters (cm) to several meters (m).

The controller 180 causes the work vehicle 100 to travel along the target path 45 that has been set. For example, the controller 180 performs steering control for the work vehicle 100 so as to reduce or minimize the deviation of the position and orientation of the work vehicle 100 with respect to the target path 45. As a result, the work vehicle 100 can be made to travel along the target path 45.

The obstacle map 40 shown in FIG. 8 is an occupancy grid map having a plurality of grid cells that are arranged in a two-dimensional array. Although FIG. 8 illustrate 16×16=256 grid cells, the number of grid cells may be arbitrary. Without being limited to the illustrated example, the obstacle map 40 may be a map (e.g., a voxel map) indicating a three-dimensional distribution of geographic features existing around the work vehicle 100, for example. Alternatively, the obstacle map 40 may be a map data of other formats, e.g., a point cloud map.

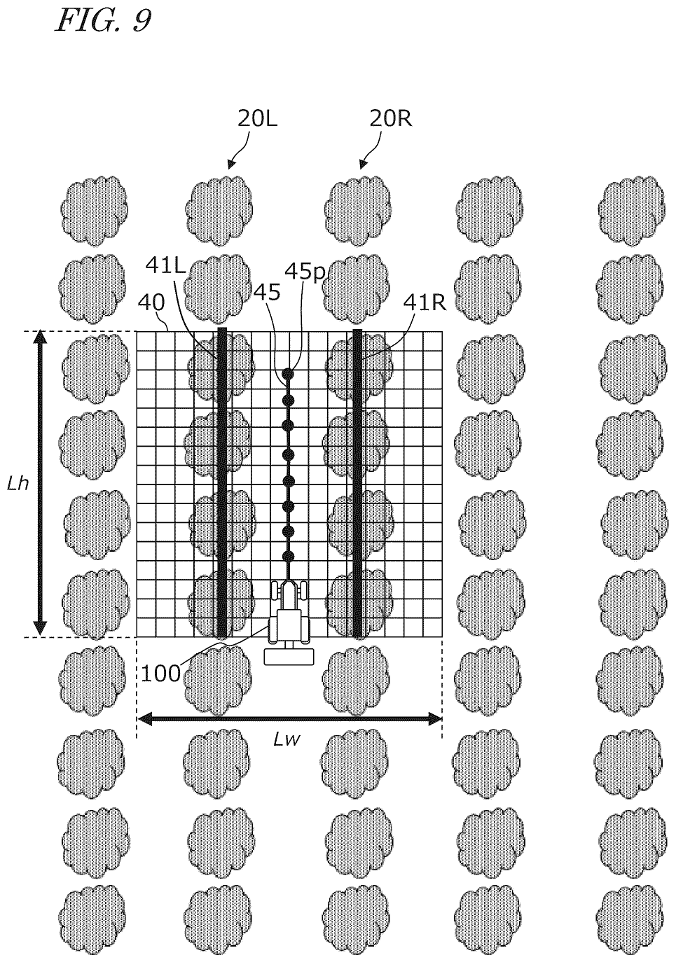

The obstacle map 40 moves together with the work vehicle 100. FIG. 9 is a diagram showing an obstacle map 40 that moves together with the work vehicle 100. The work vehicle 100 shown in FIG. 9 has moved forward from the work vehicle 100 shown in FIG. 8, so that the obstacle map 40 has also moved forward.

The controller 180 may generate the obstacle map 40 by eliminating data of any points that are estimated as corresponding to unwanted objects, e.g., the ground surface and weeds, from the sensor data that is output from the LiDAR sensor(s) 140. In a case where three-dimensional point cloud data is output as the sensor data, from the point cloud data, the controller 180 may extract only the data of points whose height from the ground surface is within a predetermined range (e.g., within a range of 0.1 m to 1.5 m), and generate the obstacle map from the extracted data of points. By such a method, an obstacle map indicating a distribution of trees (mainly the trunks) can be generated.

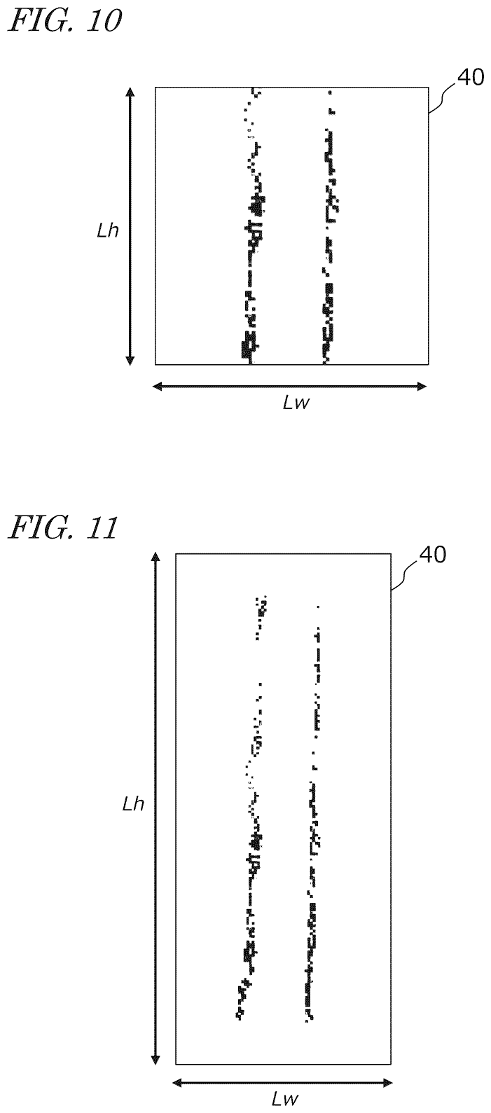

FIG. 10 is a diagram showing an example of the obstacle map 40 being generated based on sensor data. In the obstacle map 40 shown in FIG. 10, grid cells in which objects exist are depicted as dark, while grid cells in which no objects exist are depicted as blank. The dark grid cells indicate the presence of objects such as tree trunks or leaves. The obstacle map 40 may be expressed by data in which numerical value “1” is assigned to any grid cell in which an object exists and numerical value “0” is assigned to any grid cell in which no object exists, for example. The controller 180 may be configured so as to consecutively generate the obstacle map 40 as shown in FIG. 10 based on sensor data that is acquired by the LiDAR sensor(s) 140 through one cycle of scanning. For each cycle of scanning, the obstacle map 40 may be updated. The obstacle map 40 may include not only two-dimensional positional information as illustrated, but also information of height from the ground surface or the horizontal plane. The controller 180 may extract only the points whose height is within a predetermined range to generate the obstacle map 40 indicating the distribution of rows of trees. The controller 180 may merge the sensor data that is output from a plurality of LiDAR sensors 140 to generate one obstacle map 40. For example, the sensor data that is output from two LiDAR sensors 140 (FIG. 1) that are disposed in the front and the rear of the work vehicle 100 may be merged to generate one obstacle map 40. Alternatively, sensor data equivalent to a plurality of cycles may be merged to generate one obstacle map. In the example of FIG. 10, the length Lh and the width Lw of the obstacle map 40 are equal, however, the length Lh and the width Lw may be different. For instance, as in the example shown in FIG. 11, the length Lh of the obstacle map 40 may be longer than its width Lw.

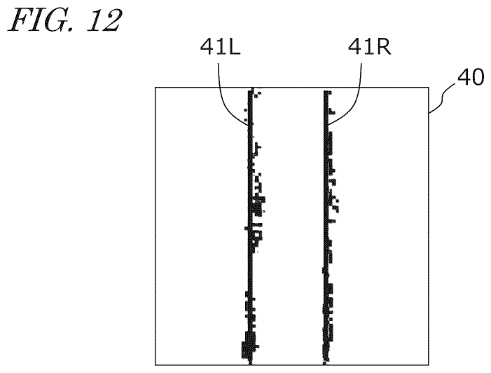

Based on the obstacle map 40, the controller 180 detects two rows of trees 20R and 20L existing on opposite sides of the work vehicle 100. For example, as shown in FIG. 12, the controller 180 can detect two rows of trees 20R and 20L by determining two approximate straight lines 41R and 41L (or approximate curves) from a plurality of rows of points that are distributed along the traveling direction of the work vehicle 100.

Next, control of the steering angle of the wheels responsible for steering 104F will be described.

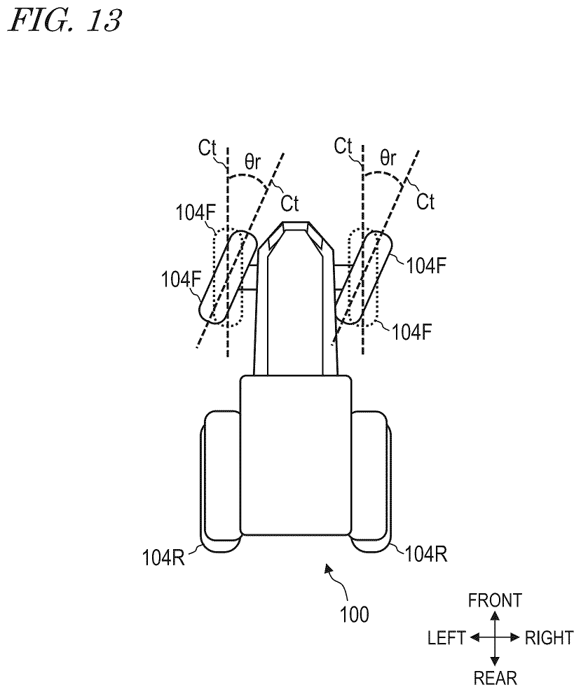

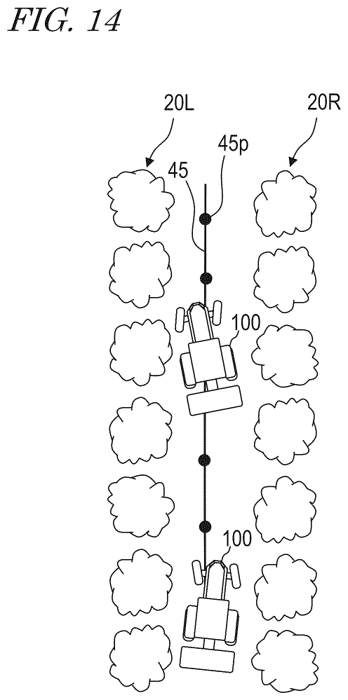

FIG. 13 is a diagram describing a steering angle θᵣ of the front wheels 104F, which are wheels responsible for steering. The reference symbols Ct in FIG. 13 indicate tire center lines of the wheels responsible for steering 104F. The steering angle θᵣ is, in a plan view of the work vehicle 100, an angle of the tire center line Ct of each wheel responsible for steering 104F with respect to the direction (0 degrees) of the tire center line Ct of the wheel responsible for steering 104F when the work vehicle 100 is in a state of traveling straight on a flat path that is horizontal. FIG. 13 illustrates a steering angle θᵣ in a case where the work vehicle 100 turns right, as an example.

FIG. 14 is a diagram showing an operation of causing the work vehicle 100 to follow the target path 45. During self-driving of the work vehicle 100, the ECU 184 (FIG. 2) performs a control of causing the work vehicle 100 to follow the target path 45. Causing the work vehicle 100 to follow the target path 45 includes causing the work vehicle 100 to head toward a next waypoint 45p. If the work vehicle 100 is deviated to the right from the target path 45, the ECU 184 may perform a control of changing the steering angle θᵣ of the wheels responsible for steering 104F in the direction of turning left. If the work vehicle 100 is deviated to the left from the target path 45, the ECU 184 may perform a control of changing the steering angle θᵣ of the wheels responsible for steering 104F in the direction of turning right. The ECU 184 sends a command to change the steering angle to the ECU 182. By controlling the steering device 106 in response to the command to change the steering angle, the ECU 182 changes the steering angle θᵣ of the wheels responsible for steering 104F.

When the work vehicle 100 performs self-traveling between crop rows 20, it is desirable to control the steering angle θᵣ so that the work vehicle 100 is prevented from coming into unwanted contact with the crop rows 20.

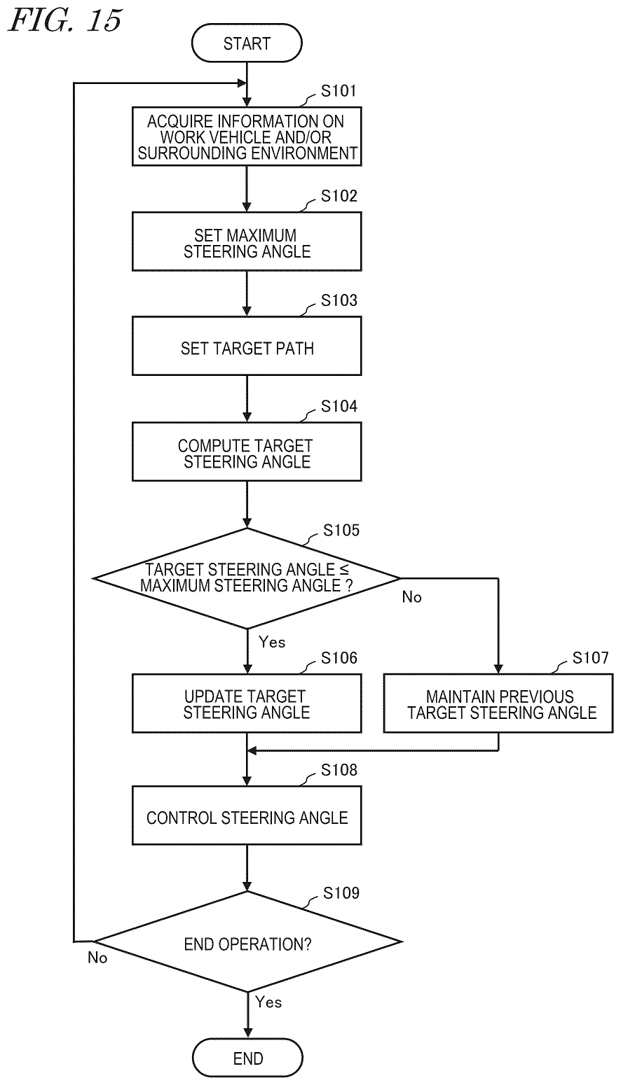

FIG. 15 is a flowchart showing an example of a process of controlling the steering angle θᵣ of the wheels responsible for steering 104F.

First, the ECU 184 acquires information on at least one of the work vehicle 100 or the surrounding environment of the work vehicle 100 (step S101). Based on the information on at least one of the work vehicle 100 or the surrounding environment of the work vehicle 100, the ECU 184 sets a maximum steering angle θₘₐₓ for the wheels responsible for steering 104F (step S102). The maximum steering angle θₘₐₓ is a maximum value that can be taken by the steering angle θᵣ in the control of the steering angle θᵣ of the wheels responsible for steering 104F, and is changeable depending on the condition.

For example, the ECU 184 acquires the value of traveling speed of the work vehicle 100, and sets the maximum steering angle θₘₐₓ based on the value of traveling speed. For example, the ECU 184 can compute the traveling speed of the work vehicle 100 based on an output signal from the wheel axis sensor 156 (FIG. 2) and/or the IMU 115.

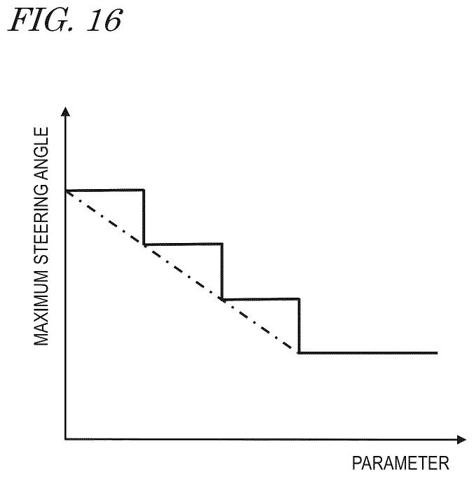

FIG. 16 is a diagram showing an example of a method of setting the maximum steering angle θₘₐₓ. In FIG. 16, the vertical axis represents the maximum steering angle θₘₐₓ, and the horizontal axis represents a parameter. The parameter is a parameter concerning the surrounding environment of the work vehicle 100 and/or the work vehicle 100. Herein, the parameter is the traveling speed of the work vehicle 100.

The ECU 184 changes the maximum steering angle θₘₐₓ in accordance with the traveling speed of the work vehicle 100. For example, the ECU 184 decreases the maximum steering angle θₘₐₓ when the traveling speed is larger than when it is smaller. For example, as shown by solid lines in FIG. 16, the maximum steering angle θₘₐₓ may be decreased in a discrete manner as the traveling speed increases. Alternatively, as shown by a dot-dash line in FIG. 16, the maximum steering angle θₘₐₓ may be decreased in a continuous manner as the traveling speed increases. Thus, by decreasing the maximum steering angle θₘₐₓ when the traveling speed is large, driving stability can be improved.

The ECU 184 sets the target path 45 for the work vehicle 100 between two rows of trees 20 (step S103). Setting of the target path 45 includes setting of waypoints 45p. As described above, based on sensor data that is output from the LiDAR sensor (s) 140 or the like, the ECU 184 detects two rows of trees 20 existing on both right and left sides of the work vehicle 100, and sets the target path 45 in between the two detected rows of trees 20.

The ECU 184 computes a target steering angle θₙ for the wheels responsible for steering 104F to cause the work vehicle 100 to follow the target path 45 (step S104). For example, the ECU 184 computes a steering angle that is needed for the work vehicle 100 to pass through a next waypoint 45p that is located forward of the work vehicle 100, and this steering angle is deemed as the target steering angle θₙ.

The ECU 184 determines which one of the target steering angle θₙ having been computed at step S104 and the maximum steering angle θₘₐₓ having been set step S102 is greater (step S105). The determination as to which one of the target steering angle θₙ and the maximum steering angle θₘₐₓ is greater can be made by finding a greater one of the absolute value of the target steering angle θₙ and the absolute value of the maximum steering angle θₘₐₓ.

If the computed target steering angle θₙ is equal to or smaller than the maximum steering angle θₘₐₓ, the ECU 184 updates the value of the target steering angle θₙ to be used to control the steering device 106 from the value of the previously-adopted target steering angle θₙ₋₁ to the value of the currently computed target steering angle θₙ (step S106).

When the computed target steering angle θₙ is greater than the maximum steering angle θₘₐₓ, the ECU 184 maintains the value of the previously-adopted target steering angle θₙ₋₁ as a value of the target steering angle θₙ to be used to control the steering device 106 (step S107).

The ECU 184 sends a command value to the ECU 182 so that the steering angle θᵣ of the wheels responsible for steering 104F equals the target steering angle θₙ determined through the processes of steps S105 to S107. By controlling the steering device 106 in accordance with the command value, the ECU 182 changes the steering angle θᵣ of the wheels responsible for steering 104F. As a result, the steering angle θᵣ of the wheels responsible for steering 104F can be controlled so that it equals the target steering angle θₙ (step S108).

The ECU 184 returns to the process of step S101, and repeats the processes from step S101 to S108. When ending the aforementioned control for the steering angle θᵣ, e.g., when finishing work between rows of trees 20, the process shown in FIG. 15 is ended (step S109).

As described above, when the computed target steering angle θₙ is greater than the maximum steering angle θₘₐₓ, the value of the previous target steering angle θₙ₋₁ is maintained, such that the steering angle of the wheels responsible for steering 104F can be controlled so as to be equal to or smaller than the maximum steering angle θₘₐₓ.

In an implementation where a maximum steering angle θₘₐₓ that is once set is never changed thereafter, the ECU 184 may return to the process of step S103 after the process of step S108. After determining the maximum steering angle θₘₐₓ at the start of travel, the maximum steering angle θₘₐₓ may be fixed to that value and not changed, or it may be changed during travel.

In a case where the target path 45 is not updated as frequently as the steering angle θᵣ is changed, the ECU 184 may return to the process of step S104 after the process of step S108. After repeating the processes from step S104 to step S108 several times, control may return to the process of any of steps S101 to S103.

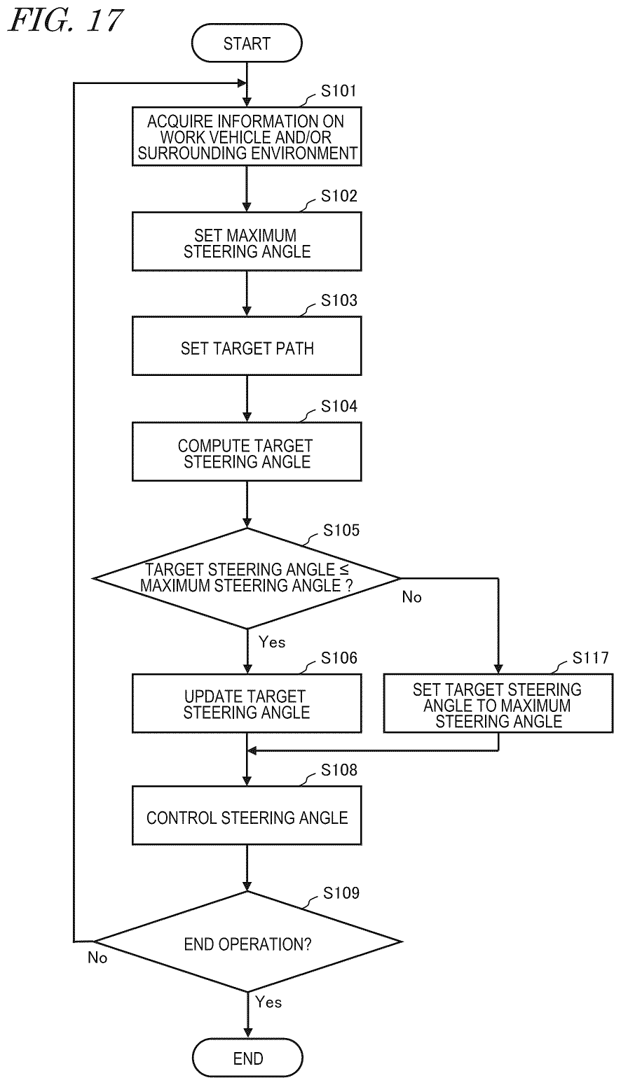

FIG. 17 is a flowchart showing another example of a process of controlling the steering angle θᵣ of the wheels responsible for steering 104F. In the process shown in FIG. 17, when the computed target steering angle θₙ is greater than the maximum steering angle θₘₐₓ, the ECU 184 sets the value of the maximum steering angle θₘₐₓ as a value of the target steering angle en to be used to control the steering device 106 (step S117). The ECU 184 performs control so that the steering angle θᵣ of the wheels responsible for steering 104F equals the target steering angle θₙ as determined through the processes of steps S105, S106 and S117 (step S108). The other processes are similar to the processes shown in FIG. 15. Thus, when the computed target steering angle θₙ is greater than the maximum steering angle θₘₐₓ, adopting the maximum steering angle θₘₐₓ, i.e., the largest adoptable value, makes it easier for the work vehicle 100 to follow the target path 45.

According to the present example embodiment, based on a state of at least one of the work vehicle 100 or the surrounding environment of the work vehicle 100, a maximum steering angle θₘₐₓ for the wheels responsible for steering 104F is set, and the steering angle θᵣ of the wheels responsible for steering 104F is controlled so as to be equal to or smaller than the maximum steering angle θₘₐₓ. By setting the maximum steering angle θₘₐₓ based on a state of at least one of the work vehicle 100 or the surrounding environment, the work vehicle 100 can be prevented from coming into contact with the rows of trees 20. By controlling the steering angle θᵣ of the wheels responsible for steering 104F so as to be equal to or smaller than the maximum steering angle θₘₐₓ, the work vehicle 100 can be prevented from coming into contact with the rows of trees 20, and driving stability can be improved.

At step S107 shown in FIG. 15, if the value of the previous target steering angle ₙ₋₁ to be maintained is greater than the latest maximum steering angle θₘₐₓ, the steering angle θᵣ of the wheels responsible for steering 104F may be controlled so as to be equal to or smaller than the latest maximum steering angle θₘₐₓ.

Moreover, for example, when the wheels responsible for steering 104F are to be steered right in order to follow the target path 45, the previous target steering angle to be maintained at step S107 may have been an angle of steering left. In that case, the steering angle θᵣ of the wheels responsible for steering 104F may be controlled to be an angle of steering right.

The ECU 184 performs control so that the steering angle θᵣ of the wheels responsible for steering 104F equals the processes of steps S105, S106, S107 and S117 target steering angle θₙ. When determining that the work vehicle 100 cannot be made to follow the target path 45 through such control of the steering angle θᵣ, the ECU 184 may perform a control of halting the work vehicle 100. For example, when determining that following the target path 45 will result in a collision with some object in the surroundings (a tree, etc.), a control of halting the work vehicle 100 may be performed.

When determining that the work vehicle 100 cannot be made to follow the target path 45, the ECU 184 may perform a control of making the traveling speed of the work vehicle 100 smaller than the current traveling speed. The ECU 184 changes the maximum steering angle θₘₐₓ based on the reduced traveling speed, and determines the target steering angle θₙ based on the changed maximum steering angle Amax. By reducing the traveling speed, the maximum steering angle θₘₐₓ can be increased. By increasing the maximum steering angle θₘₐₓ, the target steering angle θₙ can be increased, thus making it easier for the work vehicle 100 to follow the target path 45.

In the above description, the maximum steering angle θₘₐₓ is set based on the traveling speed of the work vehicle 100. Alternatively, the maximum steering angle θₘₐₓ may be set based on another parameter. For example, the ECU 184 may set the maximum steering angle θₘₐₓ based on at least one of the following parameters.
a traveling speed of the work vehicle 100
a size of the implement 300
a wheelbase of the work vehicle 100
a curvature of the rows of trees 20
a dimension between two rows of trees 20
a difference between the dimension between two rows of trees 20 and the width of the work vehicle 100
an angle of a dip of the ground surface

As a result, a maximum steering angle θₘₐₓ that is suitable for the surrounding environment of the work vehicle 100 and/or the work vehicle 100 can be set.

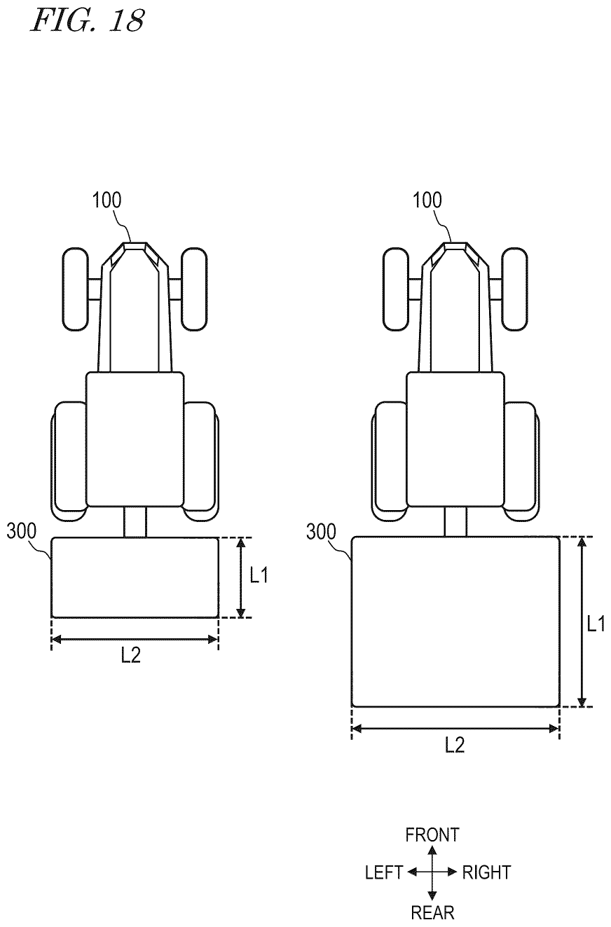

Next, an example of setting the maximum steering angle θₘₐₓ in accordance with the size of the implement 300 connected to the work vehicle 100 will be described. FIG. 18 is a diagram showing the work vehicle 100 with the implement 300 connected thereto. Information of the size of the implement 300 may be input by the user who manipulates the operation terminal 200 (FIG. 2), and stored to the storage device 170, for example. Moreover, information of the size of the implement 300 may be transmitted from the implement 300 to the work vehicle 100 via the communicators 190 and 390, and stored to the storage device 170.

The size of an implement 300 shown on the right side of FIG. 18 is greater than an implement 300 shown on the left side of FIG. 18. The ECU 184 sets the maximum steering angle θₘₐₓ to a smaller value when the size of the implement 300 is large than when it is small. For example, when the length L1 of the implement 300 along the front-rear direction is large, the maximum steering angle θₘₐₓ is set to a smaller value than when it is small. Moreover, when the length L2 of the implement 300 along the right-left direction is large, for example, the maximum steering angle θₘₐₓ is set to a smaller value than when it is small.

For example, as shown by the solid lines in FIG. 16, the maximum steering angle θₘₐₓ may be decreased in a discrete manner as the size of the implement 300 increases. Alternatively, as shown by the dot-dash line in FIG. 16, the maximum steering angle θₘₐₓ may be decreased in a continuous manner as the size of the implement 300 increases. As a result, a maximum steering angle θₘₐₓ that is suitable for the size of the implement 300 can be set. By reducing the maximum steering angle θₘₐₓ when the size of the implement 300 (length along the front-rear direction and/or length along the right-left direction) is large, the work vehicle 100 and the implement 300 can be prevented from coming into contact with the rows of trees 20.

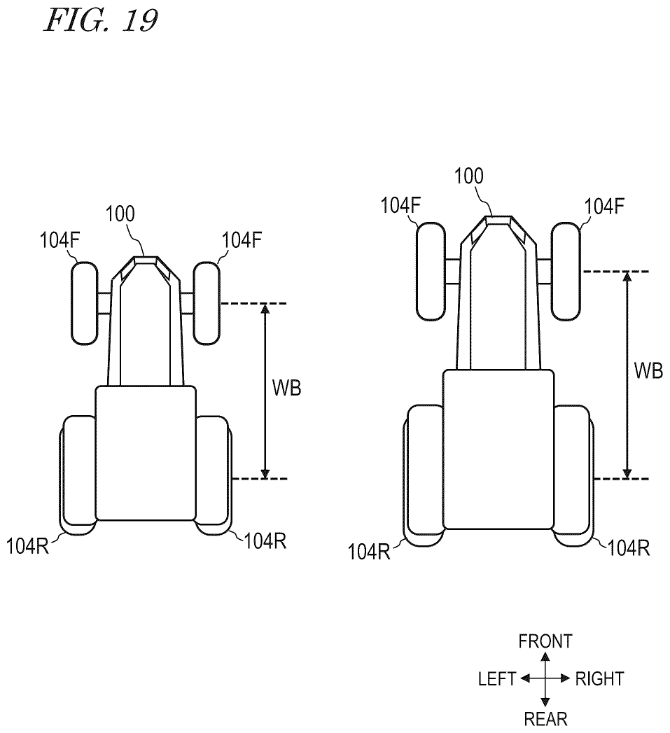

Next, an example of setting the maximum steering angle θₘₐₓ in accordance with the wheelbase of the work vehicle 100 will be described. FIG. 19 is a diagram showing a wheelbase WB of the work vehicle 100.

The wheelbase WB of a work vehicle 100 shown on the right side of FIG. 19 is larger than the wheelbase WB of a work vehicle 100 shown on the left side of FIG. 19. When the wheelbase WB of the work vehicle 100 is large, the ECU 184 sets the maximum steering angle θₘₐₓ to a larger value than when it is small.

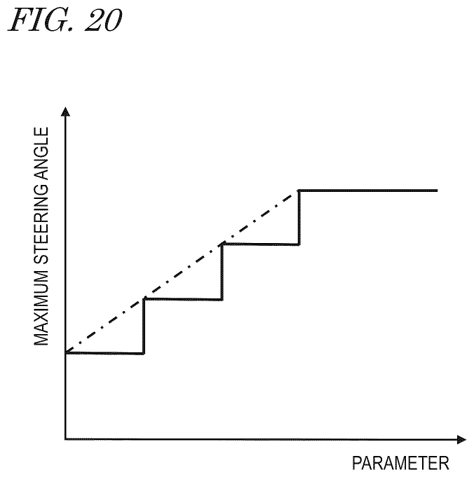

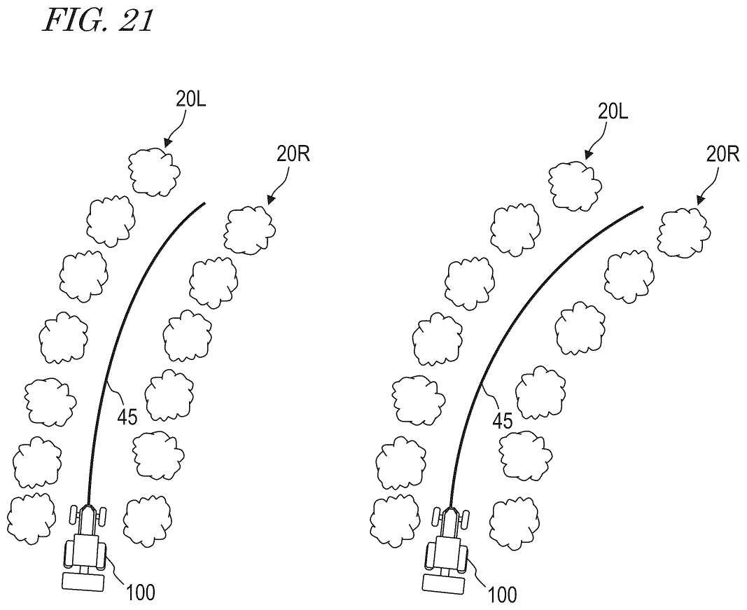

FIG. 20 is a diagram showing an example of a method of setting the maximum steering angle θₘₐₓ. In FIG. 20, the vertical axis represents the maximum steering angle θₘₐₓ, and the horizontal axis represents a parameter. The parameter is a parameter concerning the surrounding environment of the work vehicle 100 and/or the work vehicle 100. Herein, the parameter is the wheelbase WB.

For example, the ECU 184 makes the maximum steering angle θₘₐₓ larger when the wheelbase WB is large than when it is small. For example, as shown by solid lines in FIG. 20, the maximum steering angle θₘₐₓ may be increased in a discrete manner as the wheelbase WB increases. Alternatively, as shown by a dot-dash line in FIG. 20, the maximum steering angle θₘₐₓ may be increased in a continuous manner as the wheelbase WB increases. When the wheelbase WB is large, the turning radius is likely to become large. By increasing the maximum steering angle θₘₐₓ when the wheelbase WB is large, the minimum turning radius can be reduced. As a result, the work vehicle 100 can be prevented from coming into contact with the rows of trees 20.

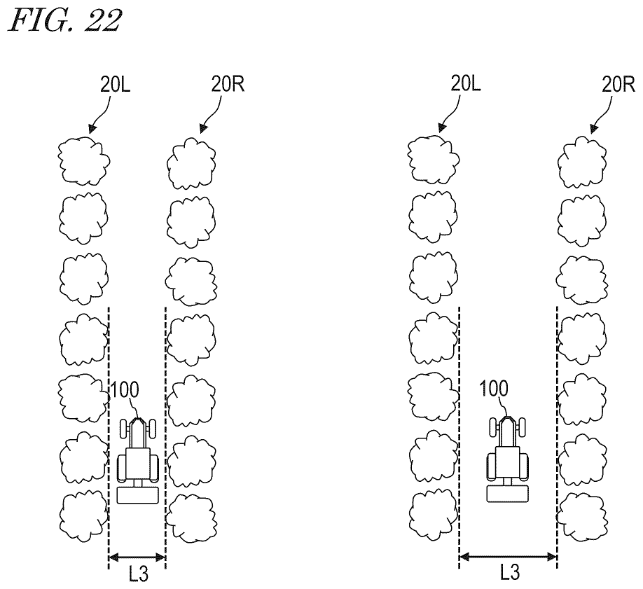

Next, an example of setting the maximum steering angle θₘₐₓ in accordance with the curvature of the row of trees 20 will be described. FIG. 21 is a diagram showing rows of trees 20. The ECU 184 changes the maximum steering angle θₘₐₓ in accordance with curvatures of two rows of trees 20L and 20R. The curvature of a target path 45 that is set between the rows of trees 20L and 20R changes in accordance with the respective curvatures of the rows of trees 20L and 20R. The respective curvatures of the rows of trees 20L and 20R can be computed from the approximate curves 41R and 41L described in FIG. 12, for example. Moreover, a mean value of the curvatures of the rows of trees 20L and 20R may be adopted as the curvature of the target path 45 that is set between the rows of trees 20L and 20R.

The curvature of the row of trees 20 shown on the right side of FIG. 21 is larger than the curvature of the row of trees 20 shown on the left side of FIG. 21. When the curvature of the row of trees 20 is large, the ECU 184 sets the maximum steering angle θₘₐₓ to a larger value than when it is small.

For example, as shown by the solid lines in FIG. 20, the maximum steering angle θₘₐₓ may be increased in a discrete manner as the curvature of the row of trees 20 increases. Alternatively, as shown by the dot-dash line in FIG. 20, the maximum steering angle θₘₐₓ may be increased in a continuous manner as the curvature of the row of trees 20 increases. As a result, a maximum steering angle θₘₐₓ that is suitable for the curvature of the row of trees 20 can be set. By increasing the maximum steering angle θₘₐₓ when the curvature of the row of trees 20 is large, the work vehicle 100 can be prevented from coming into contact with the rows of trees 20.

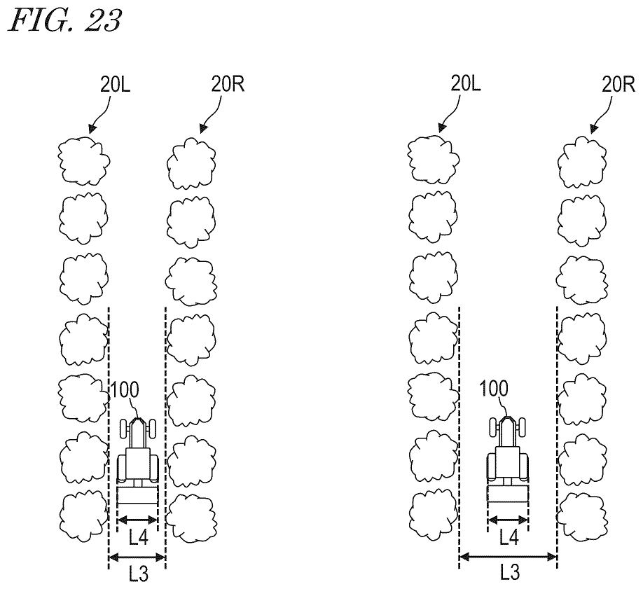

Next, an example of setting the maximum steering angle θₘₐₓ in accordance with the size of dimension between two rows of trees 20 will be described. FIG. 22 is a diagram showing rows of trees 20. The ECU 184 changes the maximum steering angle θₘₐₓ in accordance with the size of the width L3 between the two rows of trees 20L and 20R.

The sensor data that is output from the LiDAR sensor(s) 140 includes point cloud data representing the rows of trees 20. From within the point cloud data representing the rows of trees 20, the ECU 184 extracts a point that is located closer to the work vehicle 100. By computing a distance between the point extracted from within the point cloud data representing the row of trees 20L and the point extracted from within the point cloud data representing the row of trees 20R, a value of the width L3 between the two rows of trees 20L and 20R can be acquired.

The width L3 shown on the left side of FIG. 22 is smaller than the width L3 shown on the right side of FIG. 22. When the width L3 is small, the ECU 184 sets the maximum steering angle θₘₐₓ to a smaller value than when it is large.

For example, as shown by the solid lines in FIG. 20, the maximum steering angle θₘₐₓ may be decreased in a discrete manner as the width L3 decreases. Alternatively, as shown by the dot-dash line in FIG. 20, the maximum steering angle θₘₐₓ may be decreased in a continuous manner as the width L3 decreases. As a result, a maximum steering angle θₘₐₓ that is suitable for the width L3 between the rows of trees 20L and 20R can be set. By decreasing the maximum steering angle θₘₐₓ when the width L3 is small, the work vehicle 100 can be prevented from coming into contact with the rows of trees 20.

Next, an example of setting the maximum steering angle θₘₐₓ in accordance with a value D of difference between the width L3 between the rows of trees 20L and 20R and the width L4 of the work vehicle 100 will be described. FIG. 23 is a diagram showing rows of trees 20 and the work vehicle 100. The ECU 184 changes the maximum steering angle θₘₐₓ in accordance with the value of difference D between the width L3 and the width L4.

Information of the width L4 of the work vehicle 100 may be previously stored in the storage device 170. Information of the width L4 of the work vehicle 100 may be input by the user who manipulates the operation terminal 200 (FIG. 2), and stored to the storage device 170, for example.

When an implement 300 whose width is larger than that of the work vehicle 100 is connected to the work vehicle 100, a value of the width of the implement 300 may be adopted as the width L4 of the work vehicle 100. Information of the size of the implement 300 may be input by the user who manipulates the operation terminal 200 (FIG. 2), and stored to the storage device 170, for example. Moreover, information of the size of the implement 300 may be transmitted from the implement 300 to the work vehicle 100 via the communicators 190 and 390, and stored to the storage device 170.

The difference value D in the example shown on the left side of FIG. 23 is smaller than the difference value D in the example shown on the right side of FIG. 23. When the difference value D is small, the ECU 184 sets the maximum steering angle θₘₐₓ to a smaller value than when it is large.

For example, as shown in by the solid lines in FIG. 20, the maximum steering angle θₘₐₓ may be decreased in a discrete manner as the difference value D decreases. Alternatively, as shown by the dot-dash line in FIG. 20, the maximum steering angle θₘₐₓ may be decreased in a continuous manner as the difference value D decreases. As a result, a maximum steering angle θₘₐₓ that is suitable for the magnitude of the difference value D can be set. By decreasing the maximum steering angle θₘₐₓ when the difference value D is small, the work vehicle 100 can be prevented from coming into contact with the rows of trees 20.

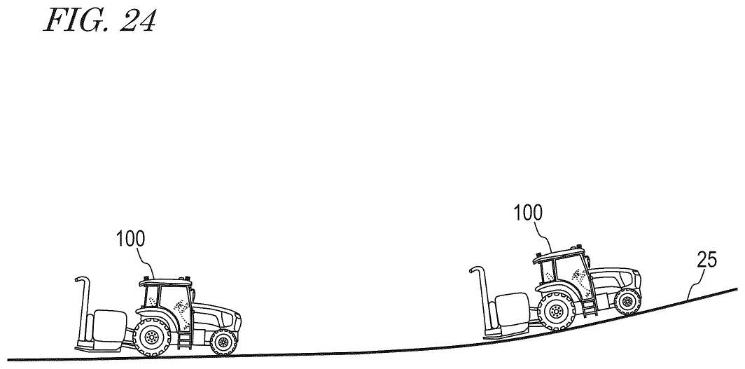

Next, an example of setting the maximum steering angle θₘₐₓ in accordance with an angle of a dip of the ground surface of a current location of the work vehicle 100 will be described. FIG. 24 is a diagram showing a work vehicle 100 and a ground surface 25 on which the work vehicle 100 travels. The ECU 184 changes the maximum steering angle θₘₐₓ in accordance with the angle of a dip of the ground surface of the current location of the work vehicle 100. The ECU 184 can compute the angle of a dip based on an output signal from the IMU 115 (FIG. 2), for example. When the ground surface of the current location of the work vehicle 100 has a large angle of a dip, the ECU 184 sets the maximum steering angle θₘₐₓ to a smaller value than when it is small.

For example, as shown by the solid lines in FIG. 16, the maximum steering angle θₘₐₓ may be decreased in a discrete manner as the angle of a dip increases. Alternatively, as shown by the dot-dash line in FIG. 16, the maximum steering angle θₘₐₓ may be decreased in a continuous manner as the angle of a dip increases. As a result, a maximum steering angle θₘₐₓ that is suitable for the angle of a dip of the current location of the work vehicle 100 can be set. By decreasing the maximum steering angle θₘₐₓ when the angle of a dip is large, driving stability can be improved.

In the above example embodiments, the one or more exterior sensors included in the work vehicle are a LiDAR sensor(s) to output two-dimensional or three-dimensional point cloud data as sensor data through scanning of a laser beam. However, the exterior sensors are not limited to such LiDAR sensors. For example, other types of sensors such as flash-type LiDAR sensors or image sensors may be used. Such other types of sensors may be used in combination with scan-type LiDAR sensors.

Although in the above example embodiments the work vehicle performs self-traveling between rows of trees in an orchard, the work vehicle may be used for the purposes of self-traveling between crop rows other than rows of trees. For example, the techniques according to example embodiments of the present disclosure are applicable to work vehicles, such as tractors, which perform self-traveling among a plurality of crop rows in an agricultural field.

Devices that perform the processing needed for the self-traveling of the work vehicle according to the above example embodiments may be mounted to a work vehicle lacking such functionality as an add-on. For example, controllers configured or programmed to control the operation of work vehicles that travel among a plurality of crop rows may be attached to the work vehicle in use.

Thus, the present disclosure encompasses work vehicles, control methods, and computer programs as recited in the following Items.

### Item 1

A work vehicle 100 to perform self-traveling among a plurality of crop rows 20, the work vehicle 100 including wheels responsible for steering 104F, a steering device 106 to change a steering angle of the wheels responsible for steering 104F, an exterior sensor 140 to output sensor data indicating a distribution of geographic features around the work vehicle 100, and a controller 160 configured or programmed to control self-traveling of the work vehicle 100, set a maximum steering angle θₘₐₓ for the wheels responsible for steering 104F based on a state of at least one of the work vehicle 100 or a surrounding environment of the work vehicle 100, detect two crop rows 20 existing on opposite sides of the work vehicle 100 based on the sensor data, set a target path 45 for the work vehicle 100 in between the two crop rows 20, compute a target steering angle θₙ for the wheels responsible for steering 104F to cause the work vehicle 100 to follow the target path 45, limit a value of the target steering angle θₙ to equal to or smaller than the maximum steering angle θₘₐₓ when the computed target steering angle θₙ is greater than the maximum steering angle θₘₐₓ, and control the steering device 106 so that the steering angle θᵣ of the wheels responsible for steering 104F equals the target steering angle θₙ.

In one example embodiment, a maximum steering angle θₘₐₓ for the wheels responsible for steering 104F is set based on a state of at least one of the work vehicle 100 or the surrounding environment of the work vehicle 100, and the steering angle θᵣ of the wheels responsible for steering 104F is controlled so as to be equal to or smaller than the maximum steering angle θₘₐₓ. By setting the maximum steering angle θₘₐₓ based on a state of at least one of the work vehicle 100 or the surrounding environment, the work vehicle 100 can be prevented from coming into contact with the crop rows 20. By controlling the steering angle θᵣ of the wheels responsible for steering 104F so as to be equal to or smaller than the maximum steering angle θₘₐₓ, the work vehicle 100 can be prevented from coming into contact with the crop rows 20, and driving stability can be improved.

### Item 2

The work vehicle 100 of Item 1, wherein the controller 160 is configured or programmed to, when the computed target steering angle θₙ is equal to or smaller than the maximum steering angle θₘₐₓ, update a value of the target steering angle θₙ to be used to control the steering device 106 from a value of a previous target steering angle θₙ₋₁ to a value of the computed target steering angle θₙ, and when the computed target steering angle θₙ is greater than the maximum steering angle θₘₐₓ, maintain a value of a previous target steering angle θₙ₋₁ as a value of the target steering angle θₙ to be used to control the steering device 106.

When the computed target steering angle θₙ is greater than the maximum steering angle θₘₐₓ, the value of the previous target steering angle θₙ₋₁ is maintained, such that the steering angle of the wheels responsible for steering 104F can be controlled so as to be equal to or smaller than the maximum steering angle θₘₐₓ.

### Item 3

The work vehicle 100 of Item 1, wherein the controller 160 is configured or programmed to, when the computed target steering angle θₙ is equal to or smaller than the maximum steering angle θₘₐₓ, update a value of the target steering angle θₙ to be used to control the steering device 106 from a value of a previous target steering angle θₙ₋₁ to a value of the computed target steering angle θₙ, and when the computed target steering angle θₙ is greater than the maximum steering angle θₘₐₓ, adopt a value of the maximum steering angle θₘₐₓ as a value of the target steering angle θₙ to be used to control the steering device 106.

When the computed target steering angle θₙ is greater than the maximum steering angle θₘₐₓ, adopting the maximum steering angle θₘₐₓ, i.e., the largest adoptable value, makes it easier for the work vehicle 100 to follow the target path 45.

### Item 4

The work vehicle 100 of any of Items 1 to 3, wherein the controller 160 is configured or programmed to set the maximum steering angle θₘₐₓ based on at least one of a traveling speed of the work vehicle 100, a wheelbase WB of the work vehicle 100, a size of an implement 300 connected to the work vehicle 100, a curvature of the two crop rows 20, an angle of a dip of a current location of the work vehicle 100, a size of a distance between the two crop rows 20, or a difference between the distance between the two crop rows 20 and a width of the work vehicle 100.

A maximum steering angle θₘₐₓ that is suitable for the surrounding environment of the work vehicle 100 and/or the work vehicle 100 can be set.

### Item 5

The work vehicle 100 of any of Items 1 to 4, wherein the controller 160 is configured or programmed to change the maximum steering angle θₘₐₓ in accordance with a traveling speed of the work vehicle 100, and make the maximum steering angle θₘₐₓ smaller when the traveling speed is larger than when the traveling speed is smaller.

A maximum steering angle θₘₐₓ that is suitable for the magnitude of the traveling speed can be set. By decreasing the maximum steering angle θₘₐₓ when the traveling speed is larger, driving stability can be improved.

### Item 6

The work vehicle 100 of any of Items 1 to 4, wherein the controller 160 is configured or programmed to change the maximum steering angle θₘₐₓ in accordance with a size of an implement 300 connected to the work vehicle 100, and make the maximum steering angle θₘₐₓ smaller when the size of the implement 300 is larger than when the size of the implement 300 is smaller.

A maximum steering angle θₘₐₓ that is suitable for the size of the implement 300 can be set. When the size of the implement 300 (length along the front-rear direction and/or length along the width direction) is larger, the work vehicle 100 and the implement 300 can be prevented from coming into contact with the crop rows 20 by reducing the maximum steering angle θₘₐₓ.

### Item 7

The work vehicle 100 of any of Items 1 to 4, wherein the controller 160 is configured or programmed to change the maximum steering angle θₘₐₓ in accordance with a curvature of the two crop rows 20, and make the maximum steering angle θₘₐₓ larger when the curvature is larger than when the curvature is smaller.

A maximum steering angle θₘₐₓ that is suitable for the curvature(s) of the crop rows 20 can be set. By increasing the maximum steering angle θₘₐₓ when the curvature(s) of the crop rows 20 is larger, the work vehicle 100 can be prevented from coming into contact with the crop rows 20.

### Item 8

The work vehicle 100 of any of Items 1 to 4, wherein the controller 160 is configured or programmed to change the maximum steering angle θₘₐₓ in accordance with an angle of a dip of a current location of the work vehicle 100, and make the maximum steering angle θₘₐₓ smaller when the angle of a dip is larger than when the angle of a dip is smaller.

A maximum steering angle θₘₐₓ that is suitable for the angle of a dip of the current location of the work vehicle 100 can be set. By decreasing the maximum steering angle θₘₐₓ when the angle of a dip is large, driving stability can be improved.

### Item 9

The work vehicle 100 of any of Items 1 to 4, wherein the controller 160 is configured or programmed to change the maximum steering angle θₘₐₓ in accordance with a size of a distance between the two crop rows 20, and make the maximum steering angle θₘₐₓ smaller when the distance between the two crop rows 20 is smaller than when the distance between the two crop rows 20 is larger.

A maximum steering angle θₘₐₓ that is suitable for the distance between two crop rows 20 can be set. By decreasing the maximum steering angle θₘₐₓ when the distance between two crop rows 20 is small, the work vehicle 100 can be prevented from coming into contact with the crop rows 20.

### Item 10

The work vehicle 100 of any of Items 1 to 4, wherein the controller 160 is configured or programmed to change the maximum steering angle θₘₐₓ in accordance with a difference between a distance between the two crop rows 20 and a width of the work vehicle 100, and make the maximum steering angle θₘₐₓ smaller when the difference is smaller than when the difference is larger.

A maximum steering angle θₘₐₓ that is suitable for the magnitude of the difference between the width between crop rows 20 and the width of the work vehicle 100 can be set. By decreasing the maximum steering angle θₘₐₓ when the difference is small, the work vehicle 100 can be prevented from coming into contact with the crop rows 20.

### Item 11

The work vehicle 100 of any of Items 1 to 4, wherein the controller 160 is configured or programmed to set the maximum steering angle θₘₐₓ in accordance with a wheelbase WB of the work vehicle 100.

A maximum steering angle θₘₐₓ that is suitable for the wheelbase WB of the work vehicle 100 can be set. For example, by increasing the maximum steering angle θₘₐₓ for a work vehicle 100 with a wheelbase WB that is large, the work vehicle 100 can be prevented from coming into contact with the crop rows 20.

### Item 12

The work vehicle 100 of any of Items 1 to 11, wherein, when determining an impossibility to cause the work vehicle 100 to follow the target path 45, the controller 160 is configured or programmed to perform a control of halting the work vehicle 100.

By halting the work vehicle 100 when determining an impossibility to cause the work vehicle 100 to follow the target path 45, the work vehicle 100 can be prevented from coming into contact with the crop rows 20.

### Item 13

The work vehicle 100 of Item 5, wherein the controller 160 is configured or programmed to, when determining an impossibility to cause the work vehicle 100 to follow the target path 45, perform a control of making the traveling speed of the work vehicle 100 smaller than a current traveling speed, change the maximum steering angle θₘₐₓ based on the reduced traveling speed, and determine the target steering angle based on the changed maximum steering angle θₘₐₓ.

When determining that the work vehicle 100 cannot be made to follow the target path 45, the maximum steering angle θₘₐₓ can be increased by reducing the traveling speed. By increasing the maximum steering angle θₘₐₓ, the target steering angle θₙ can be increased, thus making it easier for the work vehicle 100 to follow the target path 45.

### Item 14

A control method of controlling a steering angle of a work vehicle 100 to perform self-traveling among a plurality of crop rows 20, including setting a maximum steering angle θₘₐₓ for wheels responsible for steering 104F of the work vehicle 100 based on a state of at least one of the work vehicle 100 or a surrounding environment of the work vehicle 100, detecting two crop rows 20 existing on opposite sides of the work vehicle 100 based on sensor data output from an exterior sensor 140, the sensor data indicating a distribution of geographic features around the work vehicle 100, setting a target path 45 for the work vehicle 100 in between the two crop rows 20, computing a target steering angle θₙ for the wheels responsible for steering 104F to cause the work vehicle 100 to follow the target path 45, limiting a value of the target steering angle θₙ to equal to or smaller than the maximum steering angle θₘₐₓ when the computed target steering angle θₙ is greater than the maximum steering angle θₘₐₓ, and controlling a steering device of the work vehicle 100 so that the steering angle θᵣ of the wheels responsible for steering 104F equals the target steering angle θₙ.

In one example embodiment, a maximum steering angle θₘₐₓ for the wheels responsible for steering 104F is set based on a state of at least one of the work vehicle 100 or the surrounding environment of the work vehicle 100, and the steering angle θᵣ of the wheels responsible for steering 104F is controlled so as to be equal to or smaller than the maximum steering angle Amax. By setting the maximum steering angle θₘₐₓ based on a state of at least one of the work vehicle 100 or the surrounding environment, the work vehicle 100 can be prevented from coming into contact with the crop rows 20. By controlling the steering angle θᵣ of the wheels responsible for steering 104F so as to be equal to or smaller than the maximum steering angle θₘₐₓ, the work vehicle 100 can be prevented from coming into contact with the crop rows 20, and driving stability can be improved.

### Item 15

A non-transitory computer-readable medium including a computer program to cause a computer to control a steering angle of a work vehicle 100 to perform self-traveling among a plurality of crop rows 20, the computer program causing the computer to execute setting a maximum steering angle θₘₐₓ for wheels responsible for steering 104F of the work vehicle 100, based on a state of at least one of the work vehicle 100 or a surrounding environment of the work vehicle 100, detecting two crop rows 20 existing on opposite sides of the work vehicle 100 based on sensor data output from an exterior sensor 140, the sensor data indicating a distribution of geographic features around the work vehicle 100, setting a target path 45 for the work vehicle 100 in between the two crop rows 20, computing a target steering angle θₙ for the wheels responsible for steering 104F to cause the work vehicle 100 to follow the target path 45, limiting a value of the target steering angle θₙ to equal to or smaller than the maximum steering angle θₘₐₓ when the computed target steering angle θₙ is greater than the maximum steering angle θₘₐₓ, and controlling a steering device of the work vehicle 100 so that the steering angle θᵣ of the wheels responsible for steering 104F equals the target steering angle θₙ.

In one example embodiment, a maximum steering angle θₘₐₓ for the wheels responsible for steering 104F is set based on a state of at least one of the work vehicle 100 or the surrounding environment of the work vehicle 100, and the steering angle θᵣ of the wheels responsible for steering 104F is controlled so as to be equal to or smaller than the maximum steering angle θₘₐₓ. By setting the maximum steering angle θₘₐₓ based on a state of at least one of the work vehicle 100 or the surrounding environment, the work vehicle 100 can be prevented from coming into contact with the crop rows 20. By controlling the steering angle θᵣ of the wheels responsible for steering 104F so as to be equal to or smaller than the maximum steering angle θₘₐₓ, the work vehicle 100 can be prevented from coming into contact with the crop rows 20, and driving stability can be improved.

The example embodiments and techniques according to the present disclosure are applicable to work vehicles, e.g., tractors, that move in an environment in which a plurality of crop rows (e.g., rows of trees) exist, such as an orchard, an agricultural field, or a mountain forest.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A work vehicle to perform self-traveling among a plurality of crop rows, the work vehicle comprising:
wheels responsible for steering;
a steering device to change a steering angle of the wheels responsible for steering;
an exterior sensor to output sensor data indicating a distribution of geographic features around the work vehicle; and
a controller configured or programmed to:
control self-traveling of the work vehicle;
set a maximum steering angle for the wheels responsible for steering, based on a state of at least one of the work vehicle or a surrounding environment of the work vehicle;
detect two crop rows existing on opposite sides of the work vehicle based on the sensor data;
set a target path for the work vehicle in between the two crop rows;
compute a target steering angle for the wheels responsible for steering to cause the work vehicle to follow the target path;
limit a value of the target steering angle to be equal to or smaller than the maximum steering angle when the computed target steering angle is greater than the maximum steering angle; and
control the steering device so that the steering angle of the wheels responsible for steering equals the target steering angle.

2. The work vehicle of claim 1, wherein the controller is configured or programmed to:
when the computed target steering angle is equal to or smaller than the maximum steering angle, update a value of the target steering angle to be used to control the steering device from a value of a previous target steering angle to a value of the computed target steering angle; and
when the computed target steering angle is greater than the maximum steering angle, maintain a value of a previous target steering angle as a value of the target steering angle to be used to control the steering device.

3. The work vehicle of claim 1, wherein the controller is configured or programmed to:
when the computed target steering angle is equal to or smaller than the maximum steering angle, update a value of the target steering angle to be used to control the steering device from a value of a previous target steering angle to a value of the computed target steering angle; and
when the computed target steering angle is greater than the maximum steering angle, adopt a value of the maximum steering angle as a value of the target steering angle to be used to control the steering device.

4. The work vehicle of claim 1, wherein the controller is configured or programmed to set the maximum steering angle based on at least one of:
a traveling speed of the work vehicle;
a wheelbase of the work vehicle;
a size of an implement connected to the work vehicle;
a curvature of the two crop rows;
an angle of a dip of a current location of the work vehicle;
a size of a distance between the two crop rows; or
a difference between the distance between the two crop rows and a width of the work vehicle.

5. The work vehicle of claim 1, wherein the controller is configured or programmed to:
change the maximum steering angle in accordance with a traveling speed of the work vehicle; and
make the maximum steering angle smaller when the traveling speed is larger than when the traveling speed is smaller.

6. The work vehicle of claim 1, wherein the controller is configured or programmed to:
change the maximum steering angle in accordance with a size of an implement connected to the work vehicle; and
make the maximum steering angle smaller when the size of the implement is larger than when the size of the implement is smaller.

7. The work vehicle of claim 1, wherein the controller is configured or programmed to:
change the maximum steering angle in accordance with a curvature of the two crop rows; and
make the maximum steering angle larger when the curvature is larger than when the curvature is smaller.

8. The work vehicle of claim 1, wherein the controller is configured or programmed to:
change the maximum steering angle in accordance with an angle of a dip of a current location of the work vehicle; and
make the maximum steering angle smaller when the angle of the dip is larger than when the angle of the dip is smaller.

9. The work vehicle of claim 1, wherein the controller is configured or programmed to:
change the maximum steering angle in accordance with a size of a distance between the two crop rows; and
make the maximum steering angle smaller when the distance between the two crop rows is smaller than when the distance between the two crop rows is larger.

10. The work vehicle of claim 1, wherein the controller is configured or programmed to:
change the maximum steering angle in accordance with a difference between a distance between the two crop rows and a width of the work vehicle; and
make the maximum steering angle smaller when the difference is smaller than when the difference is larger.

11. The work vehicle of claim 1, wherein the controller is configured or programmed to set the maximum steering angle in accordance with a wheelbase of the work vehicle.

12. The work vehicle of claim 1, wherein, when determining an impossibility to cause the work vehicle to follow the target path, the controller is configured or programmed to perform a control of halting the work vehicle.

13. The work vehicle of claim 5, wherein the controller is configured or programmed to:
when determining an impossibility to cause the work vehicle to follow the target path, perform a control of making the traveling speed of the work vehicle smaller than a current traveling speed;
change the maximum steering angle based on the reduced traveling speed; and
determine the target steering angle based on the changed maximum steering angle.

14. A control method of controlling a steering angle of a work vehicle to perform self-traveling among a plurality of crop rows, the control method including:
setting a maximum steering angle for wheels responsible for steering of the work vehicle, based on a state of at least one of the work vehicle or a surrounding environment of the work vehicle;
detecting two crop rows existing on opposite sides of the work vehicle based on sensor data output from an exterior sensor, the sensor data indicating a distribution of geographic features around the work vehicle;
setting a target path for the work vehicle in between the two crop rows;
computing a target steering angle for the wheels responsible for steering to cause the work vehicle to follow the target path;
limiting a value of the target steering angle to be equal to or smaller than the maximum steering angle when the computed target steering angle is greater than the maximum steering angle; and
controlling a steering device of the work vehicle so that the steering angle of the wheels responsible for steering equals the target steering angle.

15. A non-transitory computer-readable medium including a computer program to cause a computer to control a steering angle of a work vehicle to perform self-traveling among a plurality of crop rows, the computer program causing the computer to execute:
setting a maximum steering angle for wheels responsible for steering of the work vehicle, based on a state of at least one of the work vehicle or a surrounding environment of the work vehicle;
detecting two crop rows existing on opposite sides of the work vehicle based on sensor data output from an exterior sensor, the sensor data indicating a distribution of geographic features around the work vehicle;
setting a target path for the work vehicle in between the two crop rows;
computing a target steering angle for the wheels responsible for steering to cause the work vehicle to follow the target path;
limiting a value of the target steering angle to be equal to or smaller than the maximum steering angle when the computed target steering angle is greater than the maximum steering angle; and
controlling a steering device of the work vehicle so that the steering angle of the wheels responsible for steering equals the target steering angle.
